(19) United States
(12) Patent Application Publication
(10) Pub. No.: US 2024/0326604 A1
(43) Pub. Date: Oct. 3, 2024

(54) MAGNETIC PROPULSION SYSTEM AND METHOD

(71) Applicant: KEYSTONE HUMANS INC., San Diego, CA (US)

(72) Inventors: Arturo Jesus FARIAS SERRA, British Columbia (CA); Juan Pablo RICO GARCIA, San Diego, CA (US)

(73) Assignee: KEYSTONE HUMANS INC., San Diego, CA (US)

(21) Appl. No.: 18/293,418

(22) PCT Filed: Jul. 29, 2022
(86) PCT No.: PCT/US2022/038907

§ 371 Date: Jan. 30, 2024

Related U.S. Application Data
(60) Provisional application No. 63/227,465, filed on Jul. 30, 2021.

(51) Int. Cl. B60L 13/04; E01B 25/30

(52) U.S. Cl. CPC B60L 13/04; E01B 25/30

(57) ABSTRACT

A magnetic propulsion system is disclosed. The system includes a track assembly, and a vessel assembly. The track assembly includes at least rail that is stationary and non-powered, and includes a magnetic array. The vessel assembly includes a rotating metal plate that interacts with the magnetic array to propel the vessel assembly along the track assembly.

### INCORPORATION BY REFERENCE

The following document is incorporated herein by reference in its entirety as if fully set forth herein: U.S. Provisional Patent Application No. 63/227,465, filed on Jul. 30, 2021.

### FIELD OF INVENTION

This application is generally related to a propulsion system, and more specifically related to a magnetic propulsion system including a track and a moving object, vessel, projectile, or vehicle.

### BACKGROUND

Magnetic propulsion systems are generally well known. Many types of applications can rely on magnetic propulsion systems, such as guideways, trains, monorails, personal rapid transit (PRT), and other vehicle or package-moving systems. Magnetic propulsion systems can rely on electromagnetic properties to provide drive or propulsion to a vehicle or vessel. Some known magnetic propulsion systems require complex or complicated coils that must be energized in order to provide propulsion.

Providing power or energy to these coils or other aspects of known magnetic propulsion systems can be complicated, energy inefficient, or otherwise undesirable.

### SUMMARY

It would be desirable to provide a magnetic propulsion system that includes an improved design with respect to complexity and efficiency.

In one aspect, a magnetic propulsion system including a track assembly and a vessel assembly, which is also referred to herein as a vehicle, is provided.

The track assembly can include a helical guideway. In one example, the helical guideway can include a plurality of magnets fixedly arranged thereon. In one configuration, the magnets are on the inside of the helical rail, closest to where the rotating reaction plate of the vessel assembly will pass. The orientation of the polarity of the magnets may be aligned radially inward from the helical rail to where the vessel assembly will pass, but one of ordinary skill in the art would understand that this orientation could vary depending on the application. For example, if a Halbach configuration is chosen for the magnets, then the orientations of the polarities of the magnets will not be all the same, and will generally not all be pointing inward.

In one aspect, a rotating element, such as a reaction plate that is attached to the vessel assembly generates a force in the direction of travel and a centering force based on interaction with magnets arranged on the guideway. The reaction plate can apply a thrust force to the vessel assembly based on forces generated due to the rotation of the reaction plate and the arrangement of the magnets. Electrical currents can be generated by the system via relative motion of the magnets and reaction plate, which are also known as “eddy currents.” These currents may generate magnetic fields which will repel the reaction plate from the magnets, thereby applying a thrust force and a centering force on the vessel assembly so that the system does not require a supplied electrical current, in one example.

The track assembly is preferably electrically static and does not require a power source. The track assembly preferably includes a plurality of permanent magnets. The track assembly preferably lacks electromagnets. However, one of ordinary skill in the art would understand that the track could be modified to include electromagnetic elements.

The vessel assembly includes at least one reaction plate. The at least one reaction plate is preferably curved, and is preferably arranged concentrically about the vessel assembly or the body of the vehicle. The vessel assembly can include a motor configured to rotate the at least one reaction plate. The motor can be provided internally relative to the vessel assembly. The reaction plate can have a thickness of 10 mm-30 mm, although one of ordinary skill in the art would understand that this range can vary. In one example, the reaction plate has a length of 1.0 m-2.0 m, although one of ordinary skill in the art would understand that this range can vary. The at least one reaction plate can be formed from metal, such as copper, in one aspect. In another aspect, the reaction plate can be formed from aluminum, which is paramagnetic, but, like copper, it has a property such that relatively moving magnets induce eddy currents in the metal, and these eddy currents generate magnetic fields that will repel the magnet. In another aspect, the reaction plate can be formed from other metals or from a non-metal, such as graphene or pyrolytic carbon.

The at least one reaction plate can include a plurality of reaction plates, that can rotate in unison or be independently operated from one another. In one aspect, an axial dimension of the at least one reaction plate can be approximately at least 50% of an axial extent of the entire vessel assembly. The reaction plate can cover a majority of the body of the vessel assembly in one aspect. The term body, as used with reference to the vessel assembly, can refer to an entire axial or longitudinal extent of the vessel assembly as shown in the Figures.

In one aspect, a gap is defined between an exterior surface of the vessel body and an interior surface of the helical array of magnets. In one aspect, this gap is preferably 100 micrometers to 10 cm. In one configuration, spacers or spacing elements can be provided either on an external surface of the vessel or on an internal facing surface of the rails. Alternatively, bearing components, wheels, rollers, or other interfacing support components can be provided. These elements can be provided for when a centering force generated by rotation of the reaction plate is insufficient to lift the vessel assembly or force the vessel assembly away from the guideway.

Rotation of the at least one reaction plate is configured to generate forces on the at least one reaction plate that are perpendicular to the longitudinal axis (X) of the track assembly (i.e. a lifting force or centering force) and parallel to the longitudinal axis (X) of the track assembly (i.e. a thrusting force or propulsion force).

In one aspect, the helical array of magnets surrounds at least 360 degrees of the reaction plate. In another aspect, the helical array of magnets surrounds at least 720 degrees of the vessel assembly. In another aspect, the helical array of magnets surrounds 10 degrees or less of the vessel assembly and reaction plate. This circumferential extent of the guideway relative to the vessel assembly is primarily controlled by the pitch of the helical profile of the guideway. In regions of the track that are generally designated as high-speed portions, the pitch can be greater, and in regions of the track that are generally designated as low speed or docking or loading portions, the pitch can be much lower in order to provide sufficient centering force capabilities. Stated differently, the pitch is the distance along the axis of the helix/helices that makes one complete turn. Therefore, in low speed areas, it is desirable to have many turns over a short distance, i.e. a lower pitch.

A method of propelling a vessel along a track is also disclosed herein. The method can include rotating a reaction plate that surrounds the vessel and is at least axially supported on a portion of the vessel such that propulsion forces and centering forces are generated, and the vessel is driven along the track. The method can include various other steps, as disclosed herein.

According to another aspect, a magnetic propulsion system is generally disclosed herein. The magnetic propulsion system includes a track assembly comprising at least one helical guideway extending along a longitudinal axis of the track assembly and having a plurality of magnets or a magnetic array arranged on an interior surface of the at least one helical guideway. A vessel assembly is included that has at least one reaction plate, and at least one motor configured to rotate the at least one reaction plate relative to the longitudinal axis such that the vessel assembly is propelled along the track assembly via rotation of the at least one reaction plate.

The at least one reaction plate can be formed as a metallic cylinder that is concentric with an outer surface of a body of the vessel assembly. The at least one reaction plate can be formed from aluminum or copper. The at least one reaction plate can include a plurality of reaction plates spaced apart from each other along an axial direction.

The motor can be arranged within an interior space defined by a body of the vessel assembly. The motor can be configured to drive a shaft connected to a first gear, and a second gear can be fixed to the at least one reaction plate. The first gear and the second gear can be matingly engaged with each other to rotate the at least one reaction plate. Other driving means or systems can be used besides gears, as one of ordinary skill in the art would appreciate.

The track assembly can be electrically static and does not require any power source. The helical guideway can have a T-shaped profile when view in cross-section and the magnetic array can be arranged on a terminal end of the T-shaped profile. The plurality of magnets or the magnetic array can consist of permanent magnets.

Rotation of the reaction plate can be configured to generate a centering force in a direction perpendicular to the longitudinal axis (X) of the track assembly and a propulsion force in a direction parallel to the longitudinal axis (X) of the track assembly.

A control assembly can be configured to provide signals to the motor. An energy storage unit can be configured to power the control assembly and the motor, and the control assembly and the energy storage unit can be arranged within an interior of the vessel assembly.

The helical guideway can include two helical guideways that are diametrically opposed from each other and extend parallel to each other along the longitudinal axis of the track assembly. Each of the two helical guideways can have a respective plurality of magnets or magnetic array arranged on an interior surface thereof.

The track assembly can further comprise suspended supports for holding the helical guideway in place.

The track assembly can further include lower support rails that extend parallel to the longitudinal axis of the track assembly. The lower support rails can include a magnetic array or magnets, bearing components, or a combination thereof.

A pitch of the helical guideway can be variable, and include at least a first track area having a first pitch and at least a second track area having a second pitch, and the first pitch can be smaller than the second pitch.

Bearing components can be incorporated throughout the vessel assembly. For example, at least one axial bearing can be provided for supporting the reaction plate relative to a body of the vessel assembly in an axial direction and at least one radial bearing can be provided for supporting the reaction plate relative to the body of the vessel assembly in a radial direction.

The vessel assembly can include an access element configured to open and close such that a user can enter and exit the vessel assembly. In one example, the access element can be formed as a transparent dome on a front portion of the vessel assembly.

The vessel assembly can include at least one vessel support provided on a lower half of the vessel assembly, and the track assembly can include at least one lower support rail. The at least one vessel support and the at least one lower support rail can be configured to engage with each other at least during a lower speed state or a rest state.

In another aspect, a magnetic propulsion system is disclosed herein that includes a track assembly having at least two helical guideways that are diametrically opposed from each other and each extend along a longitudinal axis of the track assembly. Each of the at least two helical guideways can include a magnetic array or plurality of magnets arranged on an interior surface thereof. The magnetic array or plurality of magnets can include permanent magnets. A vessel assembly can be included that has a body defining an interior space, at least one reaction plate arranged around an exterior of the body, at least one energy storage unit arranged within the interior space, and at least one motor arranged within the interior space and configured to be powered by the at least one energy storage unit to rotate the at least one reaction plate relative to the longitudinal axis such that the vessel assembly is propelled along the track assembly via rotation of the at least one reaction plate.

The motor can be configured to drive a shaft connected to a first gear, and a second gear can be fixed to the at least one reaction plate. The first gear and the second gear can matingly engage with each other to rotate the at least one reaction plate.

The body of the vessel assembly can define an opening through which the first gear protrudes to engage the second gear.

The vessel assembly can include an access element configured to open and close such that a user can enter and exit the vessel assembly, and the access element can be formed as a transparent dome on a front portion of the vessel assembly.

At least one axial bearing can be arranged between the at least one reaction plate and the body of the vessel assembly, and at least one radial bearing can be arranged between the at least one reaction plate and the body of the vessel assembly. The body of the vessel assembly can define a support surface to define an interface with the at least one axial bearing.

The vessel assembly can include a plurality of vessel supports provided on a lower half of the vessel assembly, and the track assembly can include at least one lower support rail. The plurality of vessel supports can be configured to interface with the at least one lower support rail for supporting the vessel assembly during a lower speed state or a rest state.

The body of the vessel assembly can have a diameter of 1 meter. This can be measured relative to an interior wall of the body, in one example. In another example, this can be the diameter as measured relative to an outer wall of the body.

A method of propelling a vessel assembly along a track assembly is also disclosed herein. The method can include multiple steps, such as providing a track assembly including a magnetic array fixed along at least one helical guideway. The method can include positioning a vessel assembly within an interior track defined by the helical guideway. The vessel assembly can include at least one reaction plate that surrounds a body of the vessel assembly. The method can include rotationally driving the at least one reaction plate such that at least a propulsion force is generated via interaction of the at least one reaction plate with the magnetic array and the vessel assembly is propelled along the track assembly.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1A is a side perspective view of a propulsion system according to one aspect.

FIG. 1B is a front perspective view of a propulsion system according to one aspect.

FIG. 1C is another side perspective view of a propulsion system according to one aspect and with a cutaway portion showing an interior of a vessel.

FIG. 1D is a top perspective view of a propulsion system according to one aspect and with a cutaway portion showing an interior of a vessel.

FIG. 1E is a side view of a propulsion system according to one aspect.

FIG. 1F is a front perspective view of a propulsion system according to one aspect.

FIG. 1G is a magnified view showing magnets arranged on an interior of a track of a propulsion system according to one aspect.

FIG. 1H is a further perspective view of a propulsion system according to one aspect.

FIG. 2A is a magnified perspective view of an interface between a vessel and a track according to one aspect.

FIG. 2B is a top view of interface between a vessel and a track according to one aspect.

FIG. 2C is a perspective view showing a component of a net force, according to one aspect of the propulsion system.

FIG. 2D is a schematic illustration showing forces associated with the vessel and track of the propulsion system according to one aspect.

FIG. 3A is a cutaway side view of the vessel for the propulsion system showing interior components of the vessel according to one aspect.

FIG. 3B is a side view of the internal components of the vessel according to one aspect.

FIG. 3C is a partial cutaway side view of the vessel inside of the track showing interior components of the vessel according to one aspect.

FIG. 3D is another partial cutaway side view of the vessel inside of the track showing interior components of the vessel according to one aspect.

FIG. 4A is a side view of the vessel assembly according to one aspect.

FIG. 4B is a cross-sectional view of the vessel assembly according to one aspect.

FIG. 4C is a side view of the vessel assembly and bearing components according to one aspect.

FIG. 5A is a perspective view of the guideway according to one aspect, in a straight profile for illustrative purposes.

FIG. 5B is a perspective view of the guideway according to another aspect, in a straight profile for illustrative purposes.

FIG. 5C is a perspective view of the guideway according to another aspect, in a straight profile for illustrative purposes.

FIG. 6A is a perspective view of the propulsion system illustrating an access element of the vessel in an open state.

FIG. 6B is another perspective view of the propulsion system illustrating an access element of the vessel in an open state.

FIG. 7 is a side perspective view of a propulsion system including a plurality of helical rails.

FIG. 8 is a side view of a vessel assembly including a plurality of reaction plates.

FIG. 9 is a perspective view showing the vessel assembly within a track assembly that includes a lower support rail.

FIG. 10 is an interior view of a guideway including additional lower support rails.

FIG. 11 is a side view of a propulsion system showing a relatively lower pitch for the guideway.

FIG. 12A is a side perspective view of a propulsion system including a vessel having vessel support elements.

FIG. 12B is a front view of the propulsion system of FIG. 12A.

FIG. 12C is a magnified view of the propulsion system of FIGS. 12A and 12B showing a vessel support.

FIG. 13A is a perspective view of a reaction plate assembly according to another aspect.

FIG. 13B is a perspective view of the reaction plate assembly of FIG. 13A arranged on the vessel.

### DETAILED DESCRIPTION OF THE PREFERRED EMBODIMENTS

Generally, magnetic propulsion, electromagnetic propulsion and/or levitation based on magnetic or electromagnetic propulsion can be configured to rely on forces generated by electric charge moving in the proximity of metals or other materials that react to magnetic fields. Levitation and propulsion can be generated by relative motion between magnets and a metal, such as copper, which is generally called passive magnetic levitation, and is relatively less complex than active magnetic levitation, which requires generating opposing magnetic fields via electrical current. In general, energy consumption is much greater for active magnetic levitation systems, and the components and controls required are much more complex and expensive.

Materials, such as iron, are generally attracted by magnetic fields, and other materials, such as copper and aluminum, can be repulsed by varying magnetic fields.

Magnets or electromagnets can be configured to induce electrical currents in a metal element, such as a metal plate, when the metal element is moved in close proximity to the magnets or electromagnets and moved in a direction perpendicular to an axis of an array of magnets or electromagnets. In one configuration, magnets or electromagnets can be configured in longitudinal arrays such that they will induce electrical currents in a metallic or non-metallic element, such as a metal plate. An intermediate step can occur in which the magnets induce eddy currents in the metal, and these currents generate a magnetic field that opposes the magnetic field of the magnets on the track, thereby generating repulsion to the relative movement between the reaction plate and the magnets. The induced electrical currents generate a magnetic field in some metals, such as copper or aluminum, and a force vector is produced opposing the movement of the magnet or electromagnet array relative to the metal element. Another force vector is also generated perpendicular to the metal element that will repulse the magnet or electromagnet and the metal plate. If the angle of the magnet array is changed, the closer the angle is to the direction of travel, then the more the opposing force will be reduced. The same forces will be generated if the array of magnets or electromagnets is fixed and the metal element is moving.

In one aspect, the present disclosure is directed to a system and method of propulsion and guidance of objects (i.e. vessels or vehicles), via fixing a magnet array to a helical guideway. The magnets (i.e. magnets 34 as described in further detail herein) are preferably arranged such that their main strength of the magnetic field is directed inward, perpendicularly to the main axis, i.e. longitudinal axis, of the helical guideway (i.e. guideway 32 as described in further detail herein). The magnets can be placed on the interior face of the helical track assembly, such that they will be the part of the track assembly in closest proximity to the reaction plate of the propelled vessel or projectile. The magnets can be in the form of individual rectangular prisms, trapezoidal prisms or other shapes that can form a longitudinal array that provides a magnetic field at least in the direction of the reaction plate. The magnets can also be elongated shapes of magnetized material that are straight or curved to fit the form of the helical track assembly.

The magnets can be all oriented in their polarity in the same direction, or in varying directions, such as a “Halbach Array”, to provide the desired magnetic field for varying configurations of the system. Different polarity arrangements produce different strengths of the magnetic field at different distances and directions from the magnets, and may thus be appropriate for different sizes, weights and velocities of the propelled vessels or projectiles and configurations of the track assembly. The magnet arrays may be a single linear arrangement of magnets, or may be a double row or multiple rows of magnets, as desired to generate the adequate magnetic fields for possible configurations of the system. In one example, the magnets could include commercial grade neodymium magnets. In one example, the magnets can have a strength of 30-52 Mega/Gauss Oersteds (MGOe). In one example, the magnet strength is less than this range, and in another example, the magnet strength is greater than this range. The strength of the magnets can vary, as one of ordinary skill in the art would understand depending on the scale of the particular application. In one example, a plurality or an array of 52 Mega/Gauss Oersteds (MGOe) Neodymium magnets can be used.

The disclosure is also directed to providing a curved reaction plate (i.e. reaction plate 52 as described herein) in the form of a cylindrical shell that spins about its longitudinal axis and fits closely within the inner diameter of the helical magnet array on the guideway. In one aspect, the gap between the cylindrical shell and the helical magnet array is carefully designed and set. The reaction plate is generally configured to freely rotate about the vessel assembly body 51, and also configured to apply a thrusting or propulsion force (i.e. in the axial or longitudinal direction) during rotation, as well as applying a centering force.

The cylindrical shell encloses, is attached to, or is linked to the object to be moved (i.e. the vessel or vehicle). In one aspect, this configuration provides a helical magnet array that acts as a fixed guideway for a moving object or vehicle (i.e. a vessel assembly 50 as described in further detail herein) via the magnetic interaction between the helical guideway on which magnets are fixed, and the spinning cylindrical plate. When the cylindrical plate spins inside the helical magnet array, a force component will be generated on the cylindrical plate parallel to the axis of the helix and of the cylinder, propelling the cylindrical plate along its axis and the axis of the helical magnet array, thereby pulling or propelling the vessel assembly.

Propulsion can be generated by rotating the cylindrical plate inside the helical guideway. As any point in the spinning cylindrical plate moves near or in close proximity to the magnetic array, such that a force is generated to oppose the relative movement of the plate and array. This force will have at least two main components. First, a force perpendicular to the surface of the plate and to the local axis of the array is provided. This force will repulse the cylindrical plate and thus drive the vessel to the center of the cross section of the helix of the guideway. This centering force will tend to push the spinning cylinder away from the magnet array and the guideway at all points, and towards the central axis of the helix. For every desired configuration of the system, the number, spacing, arrangement and strength of the magnets, as well as the dimensions, thickness, material and speed of rotation of the cylindrical plate will be designed so as to provide the desired forces to maintain the desired spacing between the rotating cylindrical plate and the guideway at all desired times and operating conditions. In one example, the magnets can have a length of 2 cm, a width of 2 cm, and a thickness of 2 cm. One of ordinary skill in the art would understand that the exact shape, size, and profile of the magnets will vary significantly depending on the particular requirements for a system. Additionally, the type, shape, size, etc. of the magnets can vary along a single stretch of the track. This component of the force will generate the desired and necessary lift and centering, by itself or in conjunction with other additional means of centering and lift, to maintain the moving object aligned and free to move, and not having any undesired physical contact with the array and guideway, and thus not creating any undesired friction from physical contact.

A second force that is perpendicular to the local axis of the array at every point in the array is also generated on the cylindrical plate. This force generally can be referred to as a propulsion force or driving force. Since the magnet array has a helical shape, this force will always have an angle between zero degrees and ninety degrees relative to the direction of tangential motion of the cylinder, and the generated force will be perpendicular to the local axis of the magnet array. This force vector can therefore be decomposed into two orthogonal components. A first orthogonal component will directly oppose the spinning of the cylinder, tangential to the cylinder, parallel to the direction of the tangential motion of the spinning of the cylinder. A second orthogonal component is also provided that is perpendicular to the direction of tangential motion of the spinning cylinder, and parallel to the longitudinal axis of the cylinder and of the helical guideway. This second component of the force will propel the spinning cylinder and vessel along the longitudinal axis of the helical guideway.

The cylinder can be driven to rotate by a motor or by any other internal or external means. If the cylinder is driven by an internal motor (i.e. motor 54 as described in further detail herein), the motor and associated energy storage (i.e. battery or other storage element 55, as described in further detail herein) can be arranged inside the cylinder or inside the moving body (i.e. vessel or vehicle) enclosed by or attached to the cylinder.

The motor used in the vessel can vary, as one of ordinary skill in the art would understand. In one example, the motor can include an output shaft that generally provides a rotational output force and that is connected to the reaction plate, such as via gears, belts, or other linkages. The motor can be an electric motor that includes a power or energy source, such as a battery or energy storage element. The energy storage element can be rechargeable in one aspect. Known examples of electric motors, such as those used in electric or hybrid automotive vehicles, can be adapted and used in the vessel. In one example, the motor can have an output of 30 kW-150 kW. One of ordinary skill in the art would understand that the strength of the motor would vary depending on various factors, such as the weight of the reaction plate, the power linkage between the motor and the reaction plate, and other factors.

In one embodiment, the motor and energy storage element may be positioned below the axis of the center of mass of the whole moving assembly, to counteract the counter-rotation induced by the spinning cylinder on the rest of the moving assembly. In the same or another embodiment, the cylinder itself may comprise a motor or a component of a motor. For example, an electric motor will generally have an approximately cylindrical component that spins, usually called a “rotor”, which is often a wire coil arrangement, but can be a solid metal component. The rotor is often on the internal part of the motor, but may also be on the exterior. In the case of a solid rotor on the outside of the electric motor, the rotor of such motor may be the cylindrical spinning cylinder itself, or the cylinder can be a portion of the rotor, or be connected to the rotor. In one embodiment, the cylinder can be driven by at least one linear induction and/or by at least one linear synchronous motor, and/or any other similar electromagnetic motor, which motors generally generate motion by acting on a flat reaction plate, and in this case would be acting on the curved reaction plate that is the cylinder, resulting in the rotation of the cylinder.

In one aspect, the cylinder is preferably made from aluminum or copper, which are readily available, easy to shape into cylinders and relatively low-cost, and are repulsed by a nearby moving or changing magnetic field; but may also be made from another material which behaves similarly in the proximity of varying magnetic fields, such as graphene.

In one embodiment, the cylinder is fed an electric current such that it produces additional magnetic fields. This configuration can be designed to increase power or use a cylinder as a component of the driving motor.

In another embodiment, the cylinder may contain an array of magnets or can be attached to an array of magnets, such as permanent magnets or electromagnets. This configuration can be provided to increase power or braking, or change parameters regarding spacing between the cylinder and the magnet array on the guideway.

In one aspect, there is always an angle between the tangential direction of rotation of the plate and the local longitudinal axis of the array of magnets or magnetized material. A constant or continuously varying angle will thus necessitate the array to be configured in a helix whose longitudinal axis coincides with the longitudinal axis of the spinning cylindrical reaction plate and whose inner diameter is slightly larger than that of the diameter of the spinning cylinder.

The gap between the magnetic component and the spinning cylinder can be based on the scale of the application. The gap can be designed to enable the avoidance of undesirable physical contact and to maintain the desired strength of the magnetic fields. In one aspect, this gap may be 100 micrometers to 10 cm. At high travel speeds, the vessel assembly will essentially center itself based on the magnetic interaction. At lower travel speeds or rest states, the vessel assembly and/or the track assembly may include bearings, support interfaces, or other components such that contact between the vessel assembly and the track assembly is controlled and avoids damage to either assembly.

In one aspect, the support structure for the magnet array may be formed from aluminum. In one aspect, the support structure is formed or extruded, and formed into a helical shape. The support structure includes attachment regions or portions that allow for attaching the magnetic element or elements. This helical component will in turn be supported by, and attached to, additional structural elements to give it the strength and rigidity needed for each application. In one aspect, the support structure can include a truss structure. Support structures of the kind utilized in construction crane systems may be used to support the helical element. The support structure and helical element assembly may be straight or curved into any shape required by the application. One of ordinary skill in the art would understand that the exact profile or shape of the magnet array and support structure can vary based on a particular application and its desired shape.

The pitch of a helix is the length of one complete turn of the helix, measured along the longitudinal axis of the helix, and it therefore also determines how many turns the helix has in a given length of guideway. If the helical element has a pitch of, for example, 1 meter, the helix makes one full turn for every meter of length of the guideway measured parallel to the longitudinal axis of the guideway. The pitch of the helix may be constant or locally changing along the length of the guideway. The pitch will determine the angle made by the local axis of the helix segment and the tangential component of the rotational motion of the cylinder. This angle will determine the relative magnitudes and directions of the generated force vectors, and therefore will also determine the resulting propulsion force and resistance to the spinning of the cylinder. Thus, depending on the power desired for propulsion, the pitch of the helix can have a shallow pitch for more power and less speed, as when accelerating from a low speed or standstill, or a steeper pitch for less power and more speed, as when advancing at high speed, for example.

In addition to the helical rail with the magnet arrays, additional structures may be provided to provide additional forces, based on the individual needs of a particular application. For example, additional helical rails, parallel helical rails, rings (i.e. segments of helical rails with pitch zero), and/or longitudinal rails with magnetic arrays may be added to provide additional forces. In the case of a transportation application, if the helical component alone is not strong enough to produce a repulsion force sufficient to vertically suspend the full weight of the vehicles, one or more additional longitudinal rails may be added. In one aspect, these additional rails can be arranged along the bottom or along the bottom half of the guideway to provide additional upward vertical support (e.g., magnetic levitation or wheels). The present disclosure provides varying aspects which can be customized based on the particular needs of a specific application.

In one aspect, the helical guideway can include more than one helical array. The helical guideway may include a double helical configuration, in one aspect. In this arrangement, a first helical track or array and a second helical track or array can be provided. The first and second helical arrays or tracks can be interspliced with each other. One of ordinary skill in the art would recognize from this disclosure that more than two helical paths, tracks, or arrays, can be used.

In one aspect, the vessel that is moved along inside of the helical array at least includes an interior space for receiving or supporting an object, person, or people, and at least one drive element. In one aspect, the drive element is a spinning cylinder. In other embodiments, multiple spinning cylinders can be provided. In one aspect, the at least one drive element could be formed in a different configuration than a spinning cylinder.

The at least one drive element is configured to propel any type of object. Some exemplary applications could include an object that is a projectile configured to be transported from one location to another, a vehicle, a shuttle, etc. In one aspect, the object being propelled may be a shaft.

The drive element, which may include a spinning cylinder, and the motor or element for rotating the drive element may constitute the entirety of the moving body. In another embodiment, the drive element may enclose or surround a container or vessel. In another aspect, the drive element may be a component of the assembly that it moves. In yet another aspect, the drive element may be attached or linked to additional components in order to drive movement of the additional components in some way. In yet another aspect, the drive may be external to, and detached from the vessel or projectile and act upon it temporarily to generate rotation of the at least one cylinder and hence generate propulsion. In the embodiment in which the system is a vehicle, the cylinder or cylinders may constitute a significant portion of the outer surface of a container which contains the motor elements, energy storage (i.e. battery) and/or transfer systems, support systems such as temperature control and navigation controls, the passenger or passengers and/or cargo.

To keep the moving body from rotating in a direction opposite the rotation of the cylinder, the majority of the weight inside the moving vehicle may be positioned such that it generates a compensating force due to gravity.

In one aspect, a propulsion system is provided in which there is no physical contact between the guideway and the moving object, so that there is no drag or wear due to physical contact. In one aspect, this disclosure provides a mechanically simple system with minimal moving parts as compared to other known magnetic levitation systems. In one aspect, only a single moving part is used. In one aspect, the moving part includes a cylinder driven by a linear induction motor.

In one aspect, the guideway is external to the moving object. The guideway can have a circular internal cross section that is configured to allow for the moving object to be simple in its mechanical and aerodynamic design.

In one aspect, the present disclosure is directed to a vehicle configuration in which the vehicle or moving object is configured to be driven at high vehicle speeds, such as several hundred miles per hour, which are typically difficult to achieve with physical contact systems.

By arranging a spinning plate on the outside of a moving object (as opposed to an interior space or other region of the moving object), it is possible to provide larger diameters for the spinning cylinder, which enables greater velocities of propulsion at a given rate of rotation (i.e. spinning of the cylinder). In one example, the diameter of the vehicle body and the reaction plate can be roughly 1.0 meter. In some exemplary configurations, the reaction plate can be configured to rotate at 2,000 rpm, the guideway can have a pitch of 3 meters, and the vessel can have a velocity of 360 km/h. This is just one exemplary configuration and one of ordinary skill in the art would understand that the rotational speed can vary, the pitch can vary, and therefore, the resulting velocity of the vessel would vary. The system disclosed herein can be adapted for very small vessels or very large vessels. A vessel having a diameter of 1 meter is generally considered a medium sized vessel and suitable for accommodating a passenger therein. One of ordinary skill in the art would understand that as the vessel size decreases, drag also decreases, thereby increasing velocity.

In one aspect, the cylinder can be comprised of multiple parallel thin plates joined together mechanically to collectively form a cylindrical plate, aligned with the direction of travel of the vessel. The thin plates may also be configured so as to make the rotating cylindrical plate translucent or partially transparent when spinning, through the use of transparent or hollow spacers between the multiple parallel plates. In another aspect, the cylindrical plate may contain holes or gaps of any shape so as to make it lighter or to achieve other design goals such as generating transparency or translucency when the plate is rotating at high speed.

The use of a cylindrical plate avoids the use of coils. This design therefore results in a simple system that may be less expensive and easier to manufacture than other systems that would produce magnetic fields by means of using coils that are fed an electric current.

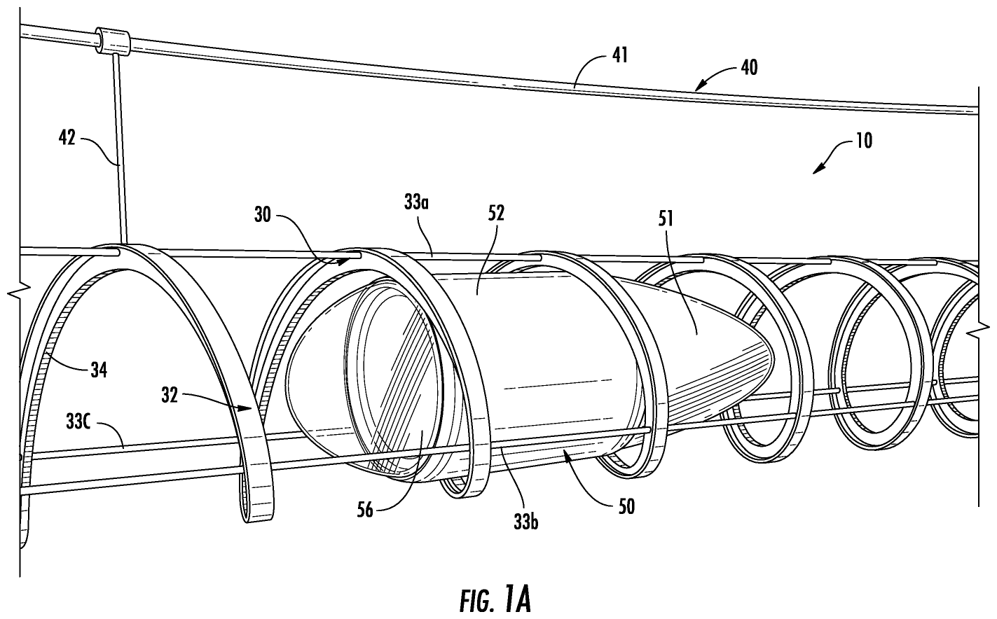

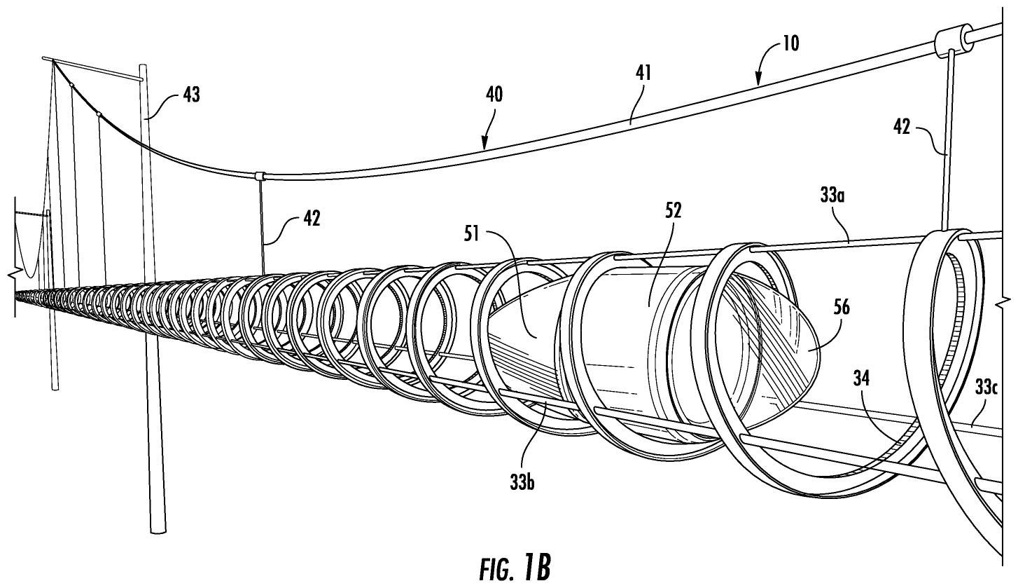

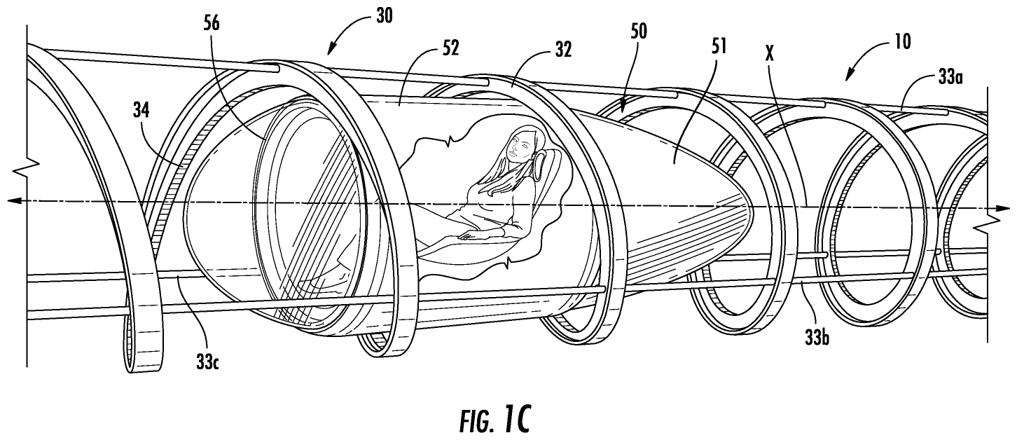

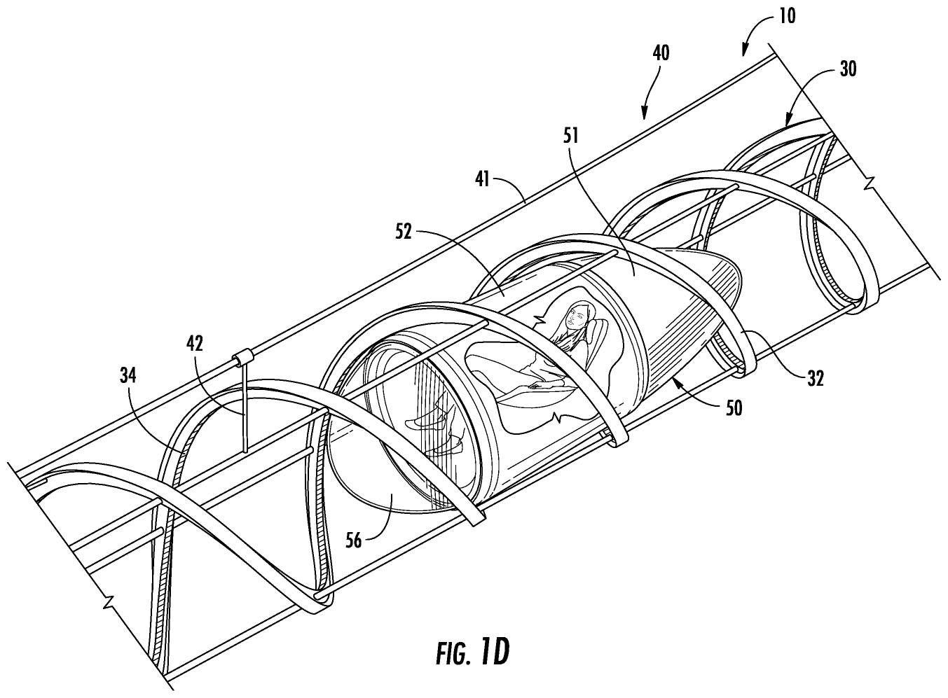

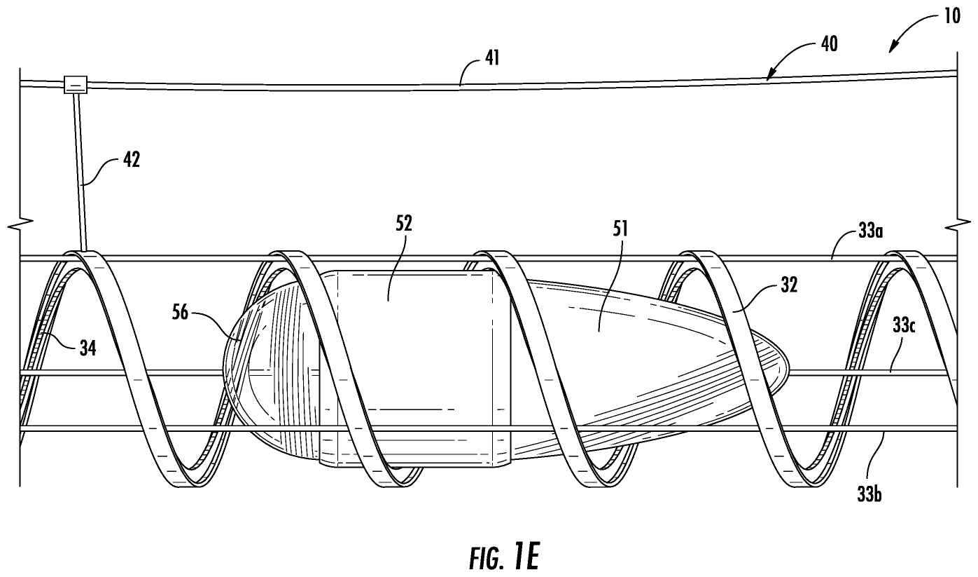

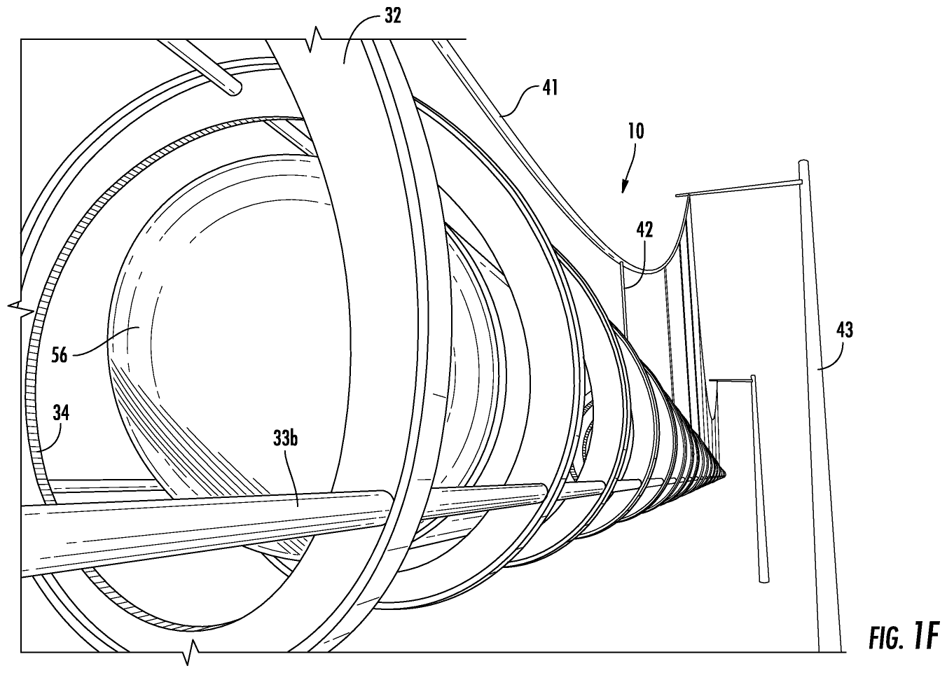

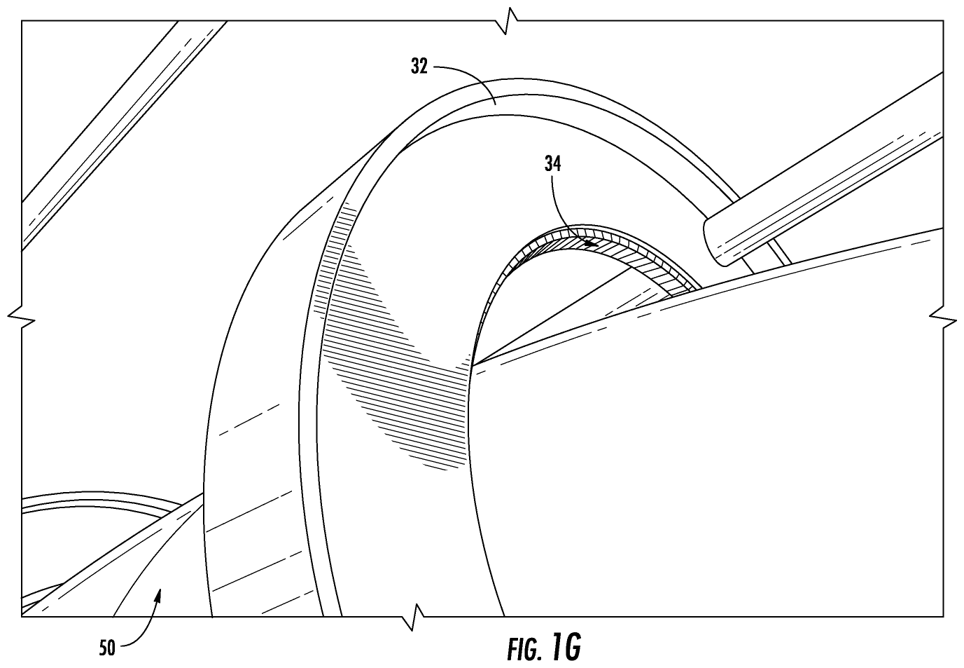

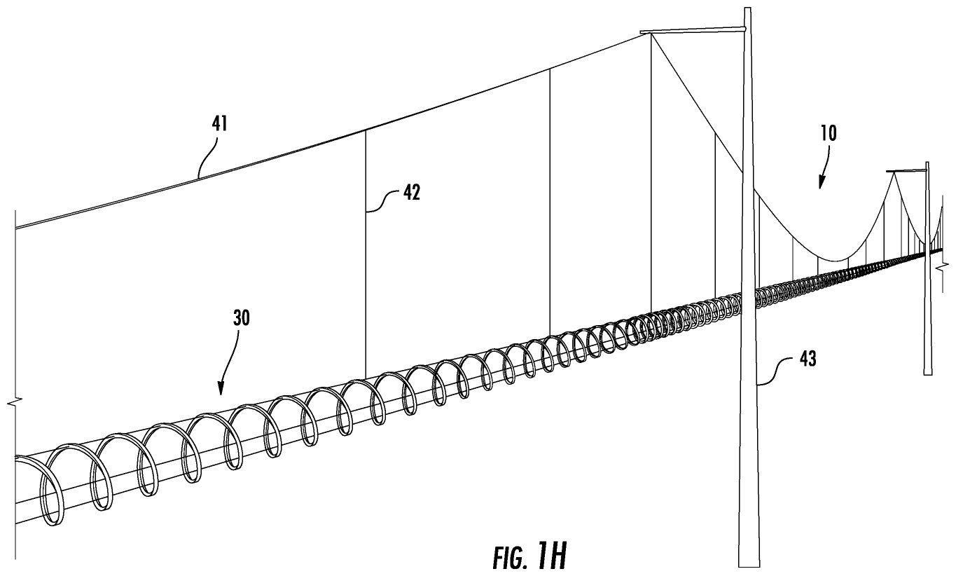

As shown in FIGS. 1A-1F, a propulsion system 10 is generally disclosed. The propulsion system 10 includes a track assembly 30 and a vessel assembly 50.

In one aspect, the track assembly 30 includes a helical guideway 32. The helical guideway 32 defines a predetermined track upon which the vessel assembly 50 is configured to be driven, propelled, or otherwise displaced. A pitch of the helical guideway 32 can vary along the track, particularly depending on the specific speed or operating requirements along different regions. For example, the pitch may be greater in “high-speed” portions, and may be lower in “low-speed” portions. The track assembly 30 can also include docking regions or boarding regions in which the vessel assembly 50 is stopped so that passengers may board the vessel assembly.

The helical guideway 32 can be supported via external supports. For example, longitudinal support rails 33a, 33b, 33c can be provided that are spaced diametrically from each other around a circumference of the vessel assembly 50. In one example, one overhead support rail 33a can be provided and two lower support rails 33b, 33c can be provided. One of ordinary skill in the art would understand that the configuration of these supports can vary depending on the requirements of a particular configuration. The support rails 33a, 33b, 33c can be suspended in air via an overhead support system 40. The overhead support system 40 can include suspension supports 41, such as cables, that generally are supported between vertical support posts 43. Hanging supports 42 can be provided that provide a connection between the suspension supports 41 and the support rails 33a, 33b, 33c or the helical guideway 32. Any one of the supports for the overhead support system 40 can be formed from rods, cables, or any other suitable support element.

Throughout the Figures, the track assembly 30 is shown with various differences and profiles, as one of ordinary skill in the art would understand due to the various different support requirements that would be necessary in different regions of the track assembly 30. In some Figures, the track assembly 30 includes lower supports configured to engage with the vessel assembly 50. In some Figures, the track assembly 30 includes a single helical guideway, while in others, the track assembly 30 includes a double helical guideway. In some Figures, hanging vertical supports are present, while in other Figures those supports are not shown. Additionally, the pitch of the track assembly 30 can vary throughout the drawings. One of ordinary skill in the art would recognize that any one or more features of the track assembly in the various Figures can be used with other aspects of features of the track assembly shown in the other Figures. Additionally, the vessel assembly 50 can operate or interface with any one or more of the various configurations shown for the track assembly. Any single track assembly 30 can also transition between various pitches, configurations (i.e. single or multiple helical guideways), etc.

The helical guideway 32 can include a magnetic array, which can include at least one magnet 34, a plurality of magnets 34, or other configuration. The term magnetic array and plurality of magnets is used interchangeably herein. In one aspect, the magnetic array or plurality of magnets 34 are fixedly arranged such that magnetic fields generated by the plurality of magnets 34 have a component of the magnetic fields towards a central axis (X) of the helical guideway 32 which is where the reaction plate (i.e. element 52) will pass and react with the magnets 34 to generate the necessary forces for the system to function.

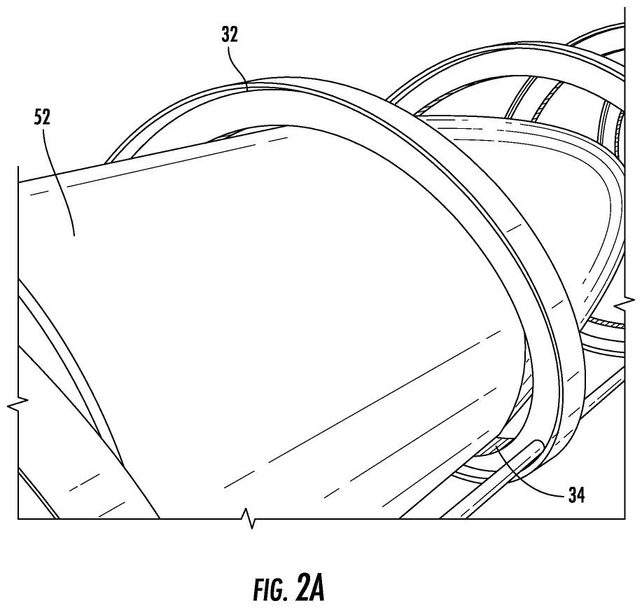

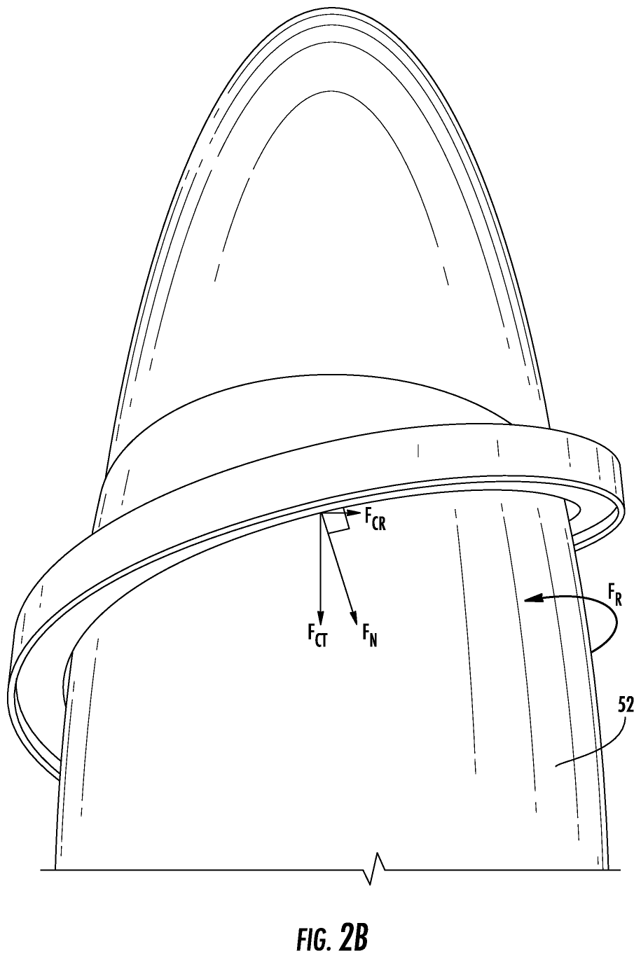

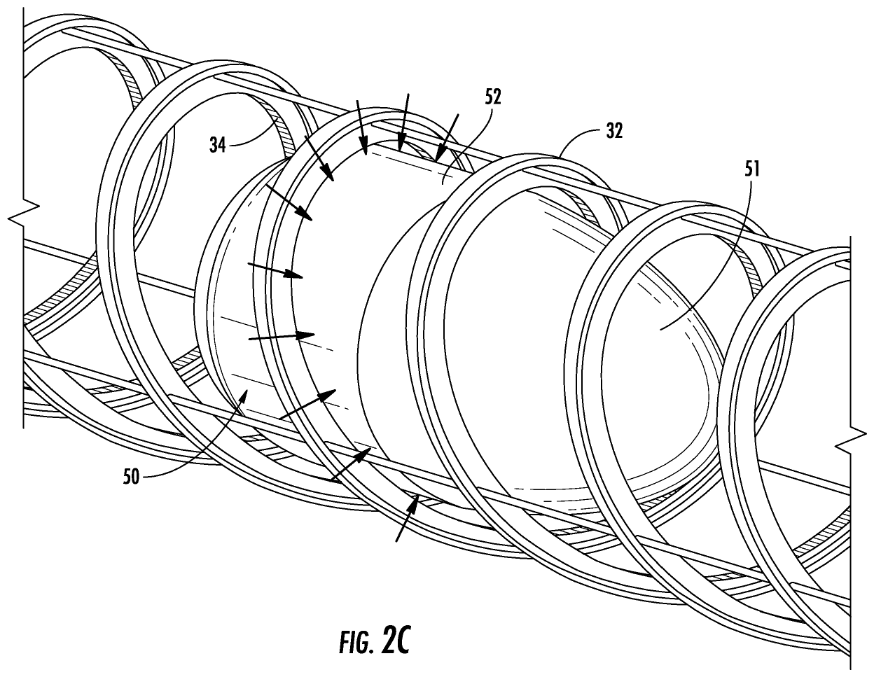

As shown in FIG. 2D, for example, the guideway 32 can be formed as T-shaped track, rail, or other component. The magnets 34 can be arranged on a terminal end of the guideway 32 that is configured to face towards the vessel assembly 50. One of ordinary skill in the art would understand that other profiles or shapes for the guideway 32 could be used.

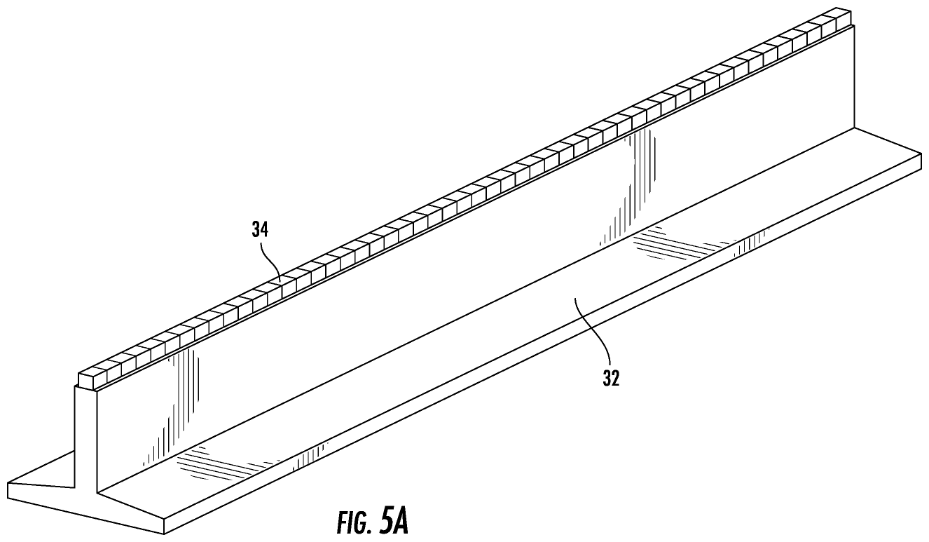

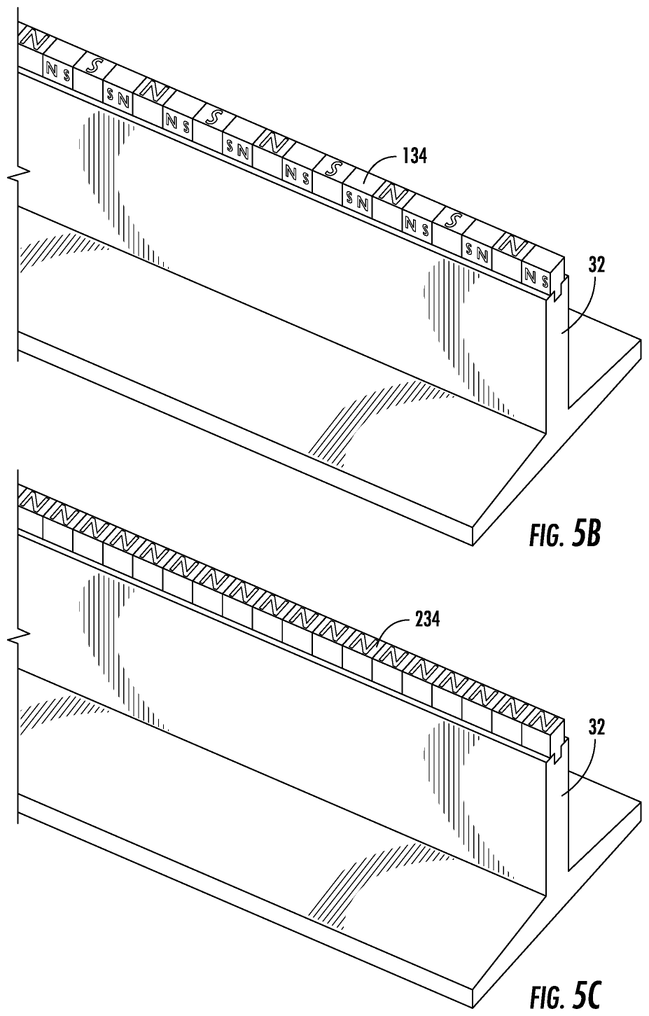

As shown in FIGS. 5A-5C, the configuration of the magnets 34 on the guideway 32 can vary. In one aspect, the magnets 34 are provided in direct abutment with each other, as shown in FIG. 5A, such that an entirety of the inner surface of the guideway 32 includes magnets 34.

Referring to FIG. 5B, in one aspect, the magnets 134 can be arranged with an alternating pattern such that the polarity of adjacent magnets varies. One common example of varying polarity orientations is the Halbach Array. In this configuration (shown in FIG. 5B), the magnetic field is made stronger on one side (the one facing away from the rail and towards the reaction plate cylinder) and weaker in the opposite direction, resulting in a stronger magnetic field in the desired direction than would be obtained by having all magnets in the same orientation.

Referring to FIG. 5C, in one aspect, the magnets 234 can be arranged in a uniform pattern with respect to their polarity and orientation. According to one aspect, this configuration may be preferable due to its ease of assembly. In the Halbach configuration, the magnets tend to repel each other while they are being put in place. This configuration may also be preferable because longer magnets can be used, thereby simplifying assembly and potentially reducing costs and maintenance.

In one aspect, the vessel assembly 50 includes at least one reaction plate 52. The reaction plate 52 can be formed with a curved profile. In one aspect, the reaction plate 52 is completely circular, i.e. extends continuously for 360 degrees.

The reaction plate 52 can be formed from metal. In one embodiment, the reaction plate 52 is formed from aluminum or copper. In one aspect, the reaction plate 52 includes a plurality of reaction plates 52a, 52b, 52c, 52d, as shown in FIG. 8. Each of these reaction plates 52a-52d function in the same way as the reaction plate 52 described herein. A single motor can be provided to drive each of the reaction plates, or a separate motor can be provided for each of the reaction plates 52a-52d. This configuration can be advantageous in order to provide the ability to counter rotate certain reaction plates 52a-52 relative to each other. This configuration could result in a holding force, i.e. no forward motion of the vessel, and provide a large centering force to prevent the vessel assembly 50 from contacting the guideway, for example during a stopped condition. Additionally, providing multiple reaction plates can provide for additional openings, supports, windows, etc. on the body 51 of the vessel instead of including a continuous reaction plate over the mid-section of the vessel.

The track assembly 30 is electrically static and does not require a power source, in one embodiment. The track assembly 30 includes a plurality of permanent magnets, in one embodiment. The track assembly 30 lacks any electromagnets, in one aspect.

In one aspect, the vessel assembly 50 consists entirely of a vessel body 51, at least one reaction plate 52 wrapped around the vessel body 51 and configured to rotate about a longitudinal axis (X) of the track assembly 30, and at least one motor 54 configured to drive rotation of the at least one reaction plate 52.

A gap can be defined between an exterior surface of the vessel body 51 and an interior of the helical array of magnets 34. In one aspect, the gap defined between an exterior surface of the vessel body 51 and an interior of the helical array of magnets 34 is 100 micrometers to 10 cm. One of ordinary skill in the art would understand that the size of the gap can vary.

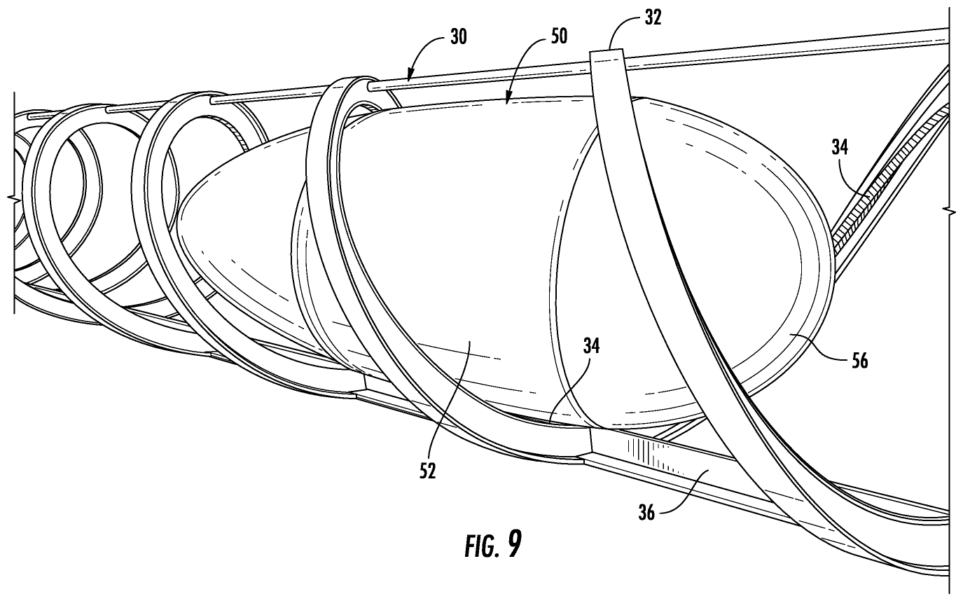

In one aspect, rotation of the at least one reaction plate 52 is configured to generate a net force on the at least one reaction plate 52 that is perpendicular to the local axis (X) of the magnets 34 mounted on the track assembly. The horizontal components of this force are shown in FIG. 2B, for example. One of these components is along the direction of rotation of the cylinder and opposed to it, generating resistance to its rotation. The other component is along the longitudinal axis of the cylinder and it provides propulsion for the vessel assembly 50 along the longitudinal axis of the track assembly 30. There is a third component of the net force, as shown in FIG. 9, which points from the magnet array, perpendicularly into the surface of the cylinder (reaction plate 52), and which generates the centering and lifting forces on the vessel assembly 50.

The relative motion between the reaction plate 52 and the magnets 34 results in electromagnetic forces that will tend oppose the relative motion of the reaction plate 52. For any point on the reaction plate 52 that approaches the magnets 34, as the point approaches a specific magnet 34, the direction of the relative approach will vary from almost parallel to the reaction plate 52, to almost perpendicular to the reaction plate 52 as the point passes right next to the magnet 34. Thus, a repulsive force will be generated perpendicular to the surface of the reaction plate 52, which will tend to center the vessel assembly 50 on the center of the helical guideway 32. This force, when large enough, will counteract gravity and support the weight of the vessel assembly 50.

A longitudinal axis of the at least one reaction plate 52 coincides with and/or is parallel with a longitudinal axis (X) of the track assembly 30, in one aspect.

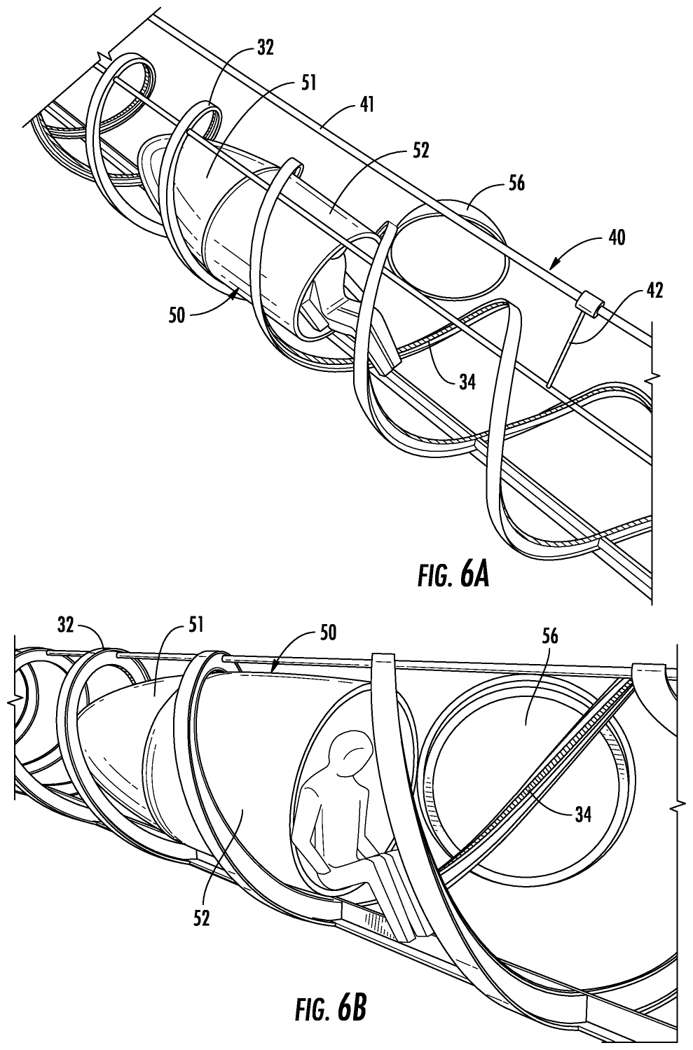

The motor 54 can be arranged on a first axial end of the vessel assembly 50 and an access element 56 can be arranged on a second, opposite axial end of the vessel assembly 50. The exact shape and configuration of the vessel assembly 50 can vary depending on the particular requirements for an application. As shown in more detail in FIGS. 6A and 6B, the access element 56 can include a hatch, door, or other component that is configured to be opened and shut to allow users to enter and exit the vessel assembly 50. The access element 56 can include a windshield that is transparent. The access element 56 can comprise a plexiglass dome held in place by a hinge on one side and at least one latch so that it may be closed securely or opened to allow the passenger or contents to enter or exit the vessel. One of ordinary skill in the art would understand that the access element 56 can be provided on other regions of the vessel assembly 50. Additionally, the manner in which the access element 56 opens and closes can vary.

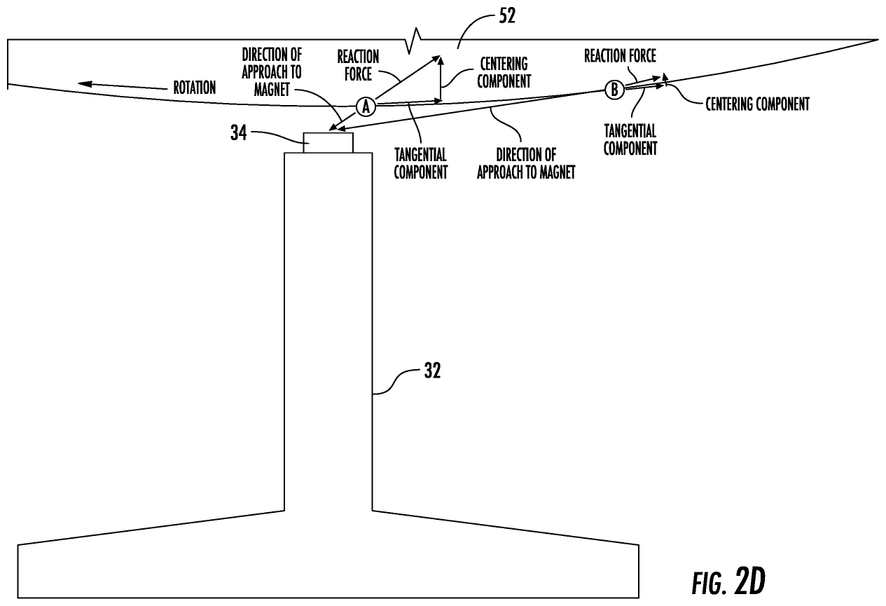

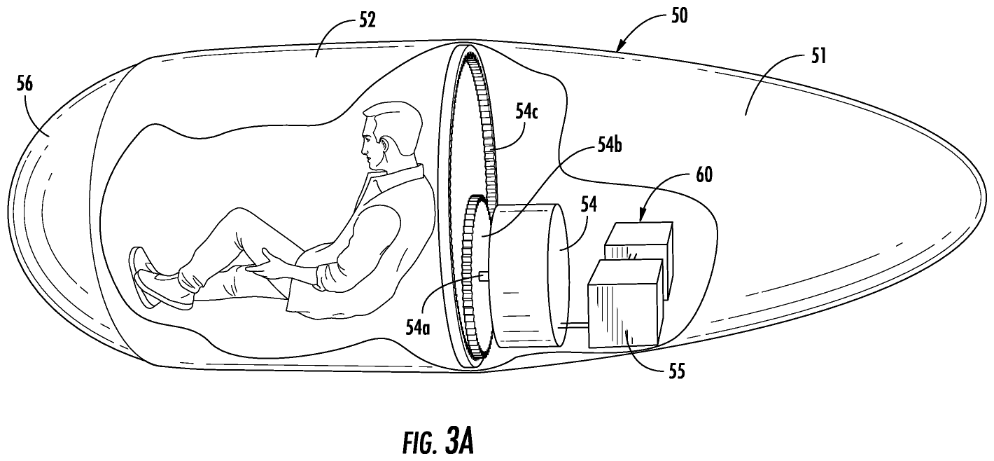

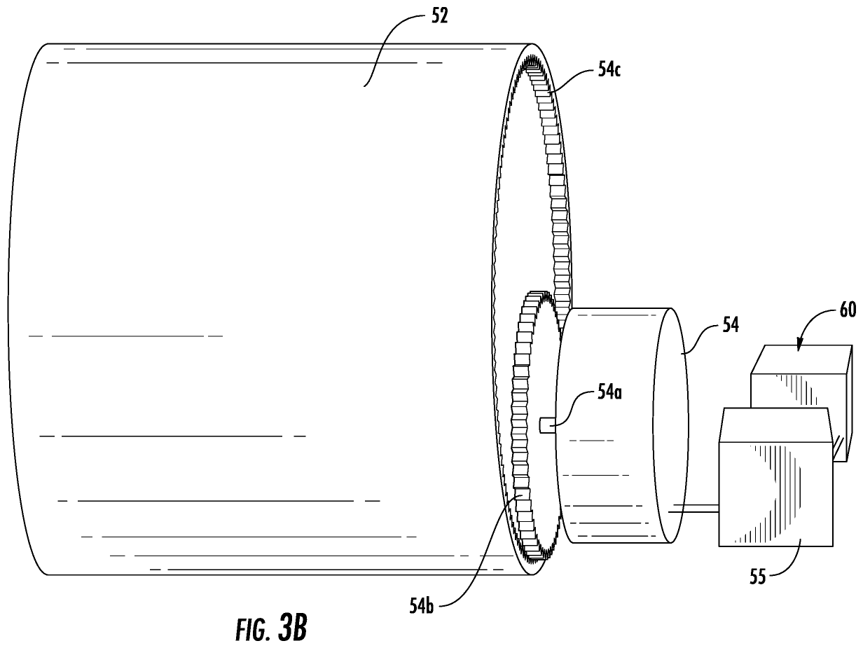

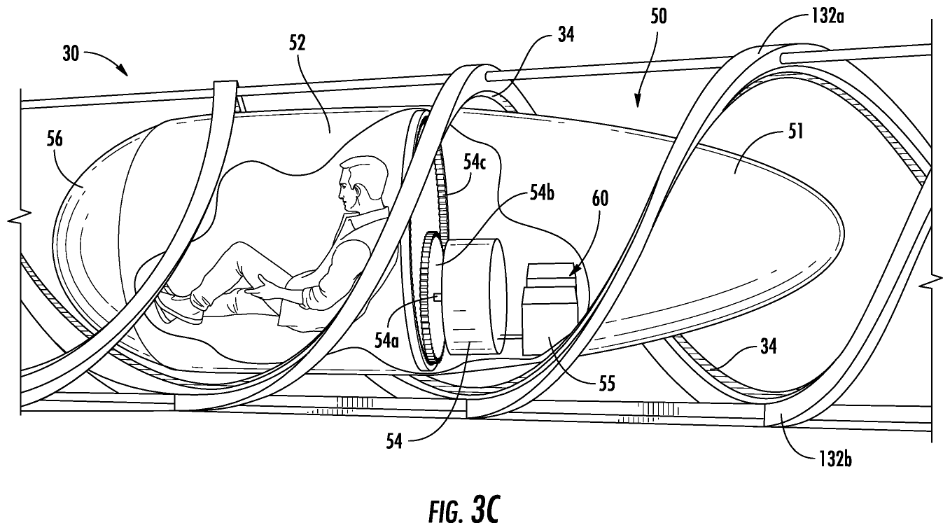

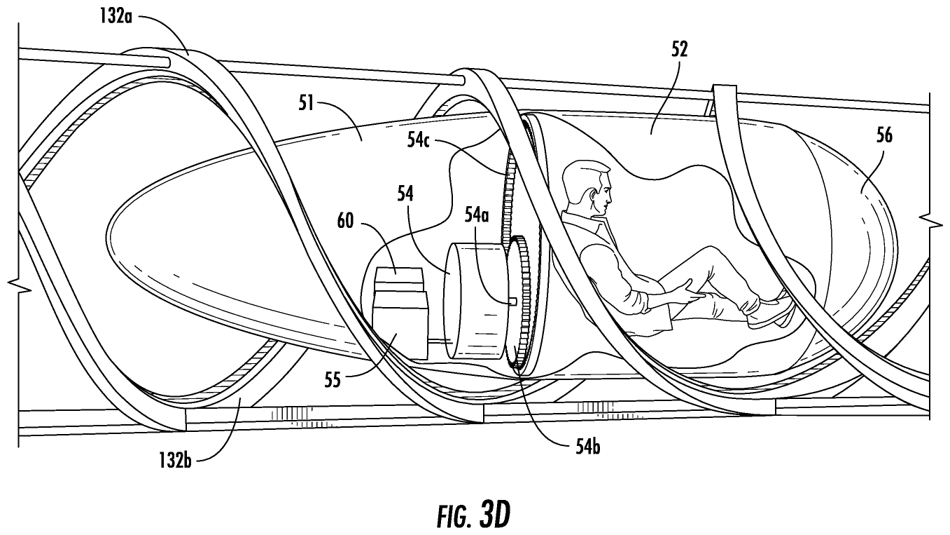

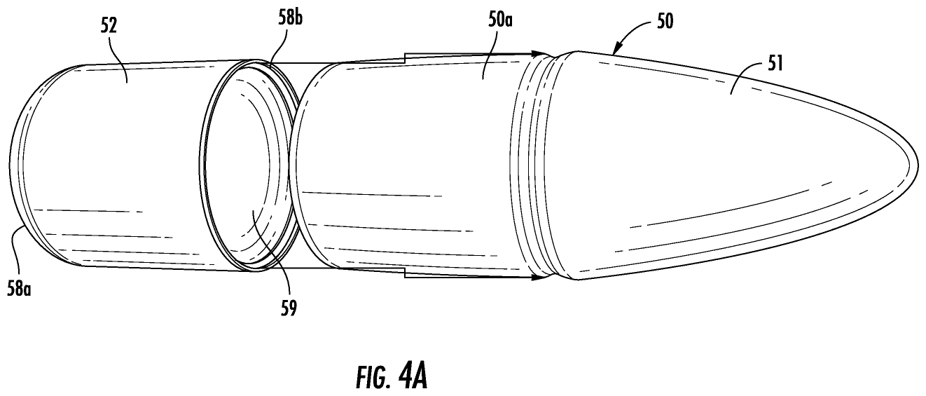

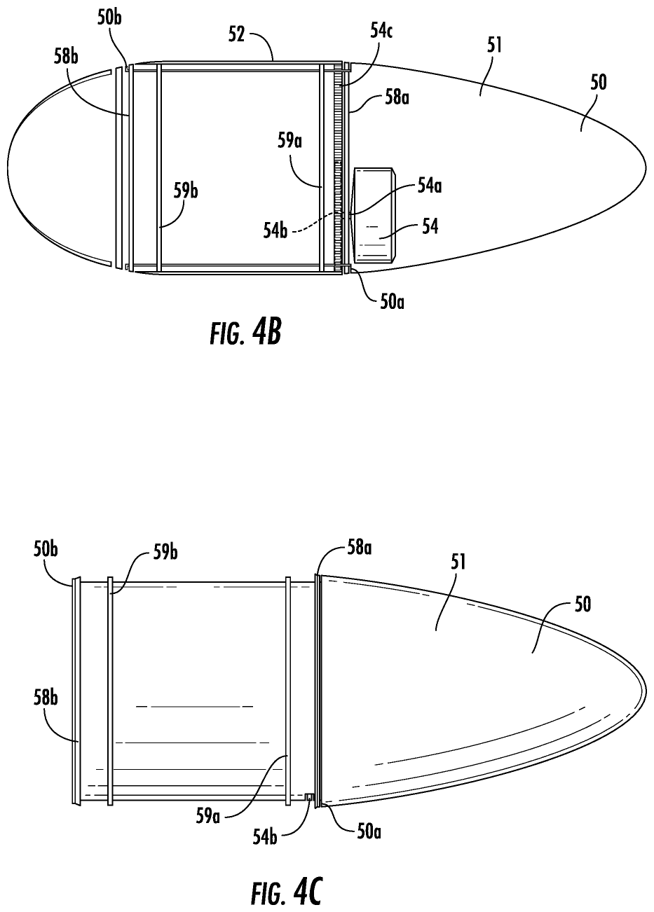

Additional details of the vessel assembly 50 are shown, for example, in FIGS. 3A-3D. The vessel assembly 50 can include a motor 54 configured to rotate the reaction plate 52. In one aspect, a mechanical linkage is provided between the motor 54 and the reaction plate 52, such that rotation from the motor 54 is used to drive the reaction plate 52. For example, a set of gears, belts, and other mechanical linkages could be used. In one configuration, the motor 54 can include a shaft 54a (i.e. an output shaft) configured to drive or rotate a first gear 54b that is matingly engaged with a second gear 54c connected or attached to the reaction plate 52. The second gear 54c can be fixed, or otherwise engaged on a radially inner surface of the reaction plate 52, for example. In one aspect, the reaction plate 52 can be integrally formed with the gear 54c. As shown in FIG. 4C, a slot, opening or window can be defined on the body 51 of the vessel assembly 50 through which a portion of the first gear 54b can protrude or extend such that it can engage with the second gear 54c. One of ordinary skill in the art would understand that other configurations can be provided so long as the gears are provided in a mating relationship.

Although just one set of gears is shown, one of ordinary skill in the art would understand that intermediate gears could be used, depending on the output that is required. Any gear box or set of gears could be adapted to be used between the motor 54 and the reaction plate 52. One of ordinary skill in the art would understand that various driving configurations can be provided between the motor 54 and the reaction plate 52, such that the reaction plate 52 is rotationally driven via the motor 54, including but not limited to belts, gears, and other mechanical linkages.

In order to support the reaction plate 52 relative to the vessel assembly 50, any one of many configurations can be used. For example, as shown in FIGS. 4A-4C, at least one bearing component can be provided. In order to support thrust or axial forces, at least one axial bearing 58a, 58b can be provided, and generally two axial bearings 58a, 58b can be provided in regions defined on the axial ends of the reaction plate 52. The axial bearings 58a, 58b can be arranged in a position between the axial ends of the reaction plate 52 and support surfaces defined on the vessel body 51. For example, the vessel body 51 can define a support surfaces 50a, 50b that are configured to provide engagement or support surfaces for respective axial bearings 58a, 58b. The support surfaces 50a, 50b on the vessel body 51 can be defined as shoulders, notches, or other surfaces. The surfaces 50a, 50b can have a radial extent or portion that provides a thrust surface or engagement surface relative to the axial bearings 58a, 58b.

To support the reaction plate 52 in the radial direction relative to the vessel body 51, additional bearing components can be provided. For example, at least one radial bearing 59a, 59b can be arranged between interfacing radial surfaces of the reaction plate 52 and the vessel body 51. In one configuration two radial bearings 59a, 59b can be provided that are spaced apart from each other in the axial direction. Alternatively, a single radial bearing can be arranged between these surfaces that generally as an axial extent that covers a majority of the radially inner surface of the reaction plate 52.

In one configuration, a combination bearing sleeve can be used that includes an axial portion defining a radial bearing surface and two radial flanges at terminal ends of the axial portion, such that a single bearing element can be used to provide axial and radial bearing support.

In one configuration, any one or more of the interfacing support faces of the bearing components can include friction reducing coatings, or the associated interfacing surfaces of the reaction plate 52 and the associated interfacing surfaces of the body of the vessel assembly 50 can include friction reducing coatings. One of ordinary skill in the art would understand that various configurations could be used such that the reaction plate 52 is freely rotatable relative to the vessel body 51 due to the rotational drive from the motor 54, and also configured to apply a thrust force to vessel body 51, while also providing minimal frictional losses or drag. Any one of the bearing components described herein can include rolling elements, a plain bearing, a hydrodynamic bearing, an air bearing, or other known bearing configuration.

A control assembly 60 can also be provided, which can be mounted on board the vessel assembly 50. In one aspect, the control assembly 60 can be configured to receive input, data, signals, or commands from a central or automated control system that can be used to control the speed of vehicles, such as via controlling the voltage or energy supplied to the motor. The control assembly 60 can generally be configured to drive the motor 54. The control assembly 60 can include a controller, processor, actuator unit, transmitter and receiver unit and other known electronic components. The control assembly 60 can be configured to provide signals, such as speed control signals, stop signals, start signals, etc., between to motor 54 to drive the reaction plate 52.

The control assembly 60 can be configured to communicate with an external component, in one example, in order to provide driving commands for the vessel assembly 50. A transmitter unit can be configured to send and receive data or signals between the vessel assembly 50 and another transmitter. A processor unit can be configured to process input commands, such as input via a user riding in the vessel assembly 50, and provide output signals or commands that are used to drive the motor 54.

An energy storage unit, battery, or other power source 55 can be connected, i.e. electrically connected, to the motor 54 or otherwise integrated with the motor 54. The energy storage unit 55 can be configured to power the motor 54 as well as the control assembly 60. In one specific example, the energy storage unit 55 can be a 10 kWh-30 kWh lithium-ion battery. One of ordinary skill in the art would understand that the battery capacity, power output, and other features can vary depending on a particular application. The energy storage unit 55 can be a rechargeable battery.

In one aspect, the energy storage element may be reduced or eliminated if the energy is provided to the motor 54 by the guideway 32 or through wireless means, such as by induction.

In one aspect, the motor 54 is provided internally relative to the vessel assembly 50. The motor 54 can be arranged inside of the vessel body 51 of the vessel assembly 50. The motor 54 can be provided externally relative to the vessel body 51, such as trailing the vessel body 51. In one aspect, the motor can have an output of 30 kW-150 kW. In one aspect, the motor can be a variable frequency AC electric motor, with a peak current of 150 Amp-210 Amp. In another aspect, the motor can be a DC brushless motor.

FIGS. 2A-2D illustrate further views to show the interface between the magnets 34 and the reaction plate 52 and the relevant forces generated by the system herein. As shown in FIG. 2B, in one aspect, rotation of the reaction plate (F_{R}) generates a net force (F_{N}) which can be composed of a component rotational force (F_{CR}) and a component travel force (F_{CT}) or propulsion force. The net force (F_{N}) can be generated at every point along the reaction plate that is in proximity to the magnets 34, tangential to the reaction plate 52, and perpendicular to a local axis of the magnets 34 based on interaction between the reaction plate 52 and the magnets 34. The net force (F_{N}) can be decomposed into the two orthogonal component forces (F_{CR}) and (F_{CT}). The component rotational force (F_{CR}) can create resistance to rotation of the reaction plate 52. The component travel force (F_{CT}) or propulsion force can drive the vessel assembly 50 along the track assembly 30. In one example, an exemplary component travel force (F_{CT}) could be 350 Newtons-500 Newtons, depending on the weight of the vessel and the passenger. The component rotational force (F_{CR}) will be relatively smaller than this force, in one aspect. In one example, as shown in FIG. 2D, the vector (F_{N}) is perpendicular to the rail and of a length such that it forms the diagonal of a rectangle whose sides or components are (F_{CR}) and (F_{CT}). In other words, (F_{N}) is the reaction force that is generated on the reaction plate 52, perpendicular to the rail, and it can be decomposed into two orthogonal vectors, (F_{CR}) and (F_{CT}).

Arrows are shown in FIG. 2C to indicate representative vectors of a centering force generated all along the magnetic array 34, and perpendicularly into the surface of the reaction plate 52. At every point on the reaction plate 52 that is in close proximity to the magnetic array 34, there will be a repulsive force acting on the reaction plate 52, which will tend to push the reaction plate 52 towards the center and away from the rails, tending to center the reaction plate 52 at all times while it is rotating.

FIG. 2D provides a further breakdown or analysis of exemplary forces generated according to one aspect of the system disclosed herein. As shown in FIG. 2D, two points A, B are shown for illustrative purposes to detail the forces generated on the surface of the reaction plate 52 during rotation in the vicinity of the magnets 34. In this state, point B will generally experience a relatively small force of repulsion, that is almost entirely along the tangential direction of motion, which can be felt as a drag component or force. At point A, which is closer to the magnet 34 than point B, a great repulsion force component will be generated and a considerably larger component force perpendicular to the point A on the reaction plate will be felt or generated. This force will generally be realized as a centering force that pushes point A upwards, thereby centering the vessel assembly 50. Points of the reaction plate 52 that are closest to the magnets 34 will experience a force that is almost exclusively a centering force (i.e. perpendicular to the outer surface of the magnets 34. In the configuration with two helical tracks, forces generated on one side of the vessel are opposed by an equivalent force on the opposite side, and thus vibration or oscillations are avoided. If the vehicle is moving fast enough, the unequal forces that would result from a single helical rail would alternate so fast that the result would at most be a slight, fast vibration and non-disruptive to the vessel. However, a double or twin helical track configuration can further address vibrational issues.

In order to support the vessel assembly 50 when the vessel assembly 50 is at rest or stopped, small spacers can be provided between the vessel body 51 and the guideway 32, such that the thickness of the spacers is smaller than the gap that will form between the vessel body 51 in motion and the guideway 32. Thus, when the reaction plate 52 begins to rotate, it will not touch the guideway 32, and as it generates a repulsion force large enough to levitate the vessel body 51, the spacers will cease to touch the guideway 32. These spacers may be fixed pieces of a suitable material (aluminum, or metal-resin composites such as the material of which car brakes are made, for example). In one example, the spacers can have a friction coating configured to withstand any friction. Alternatively, a friction coating may be omitted because the spacer generally may not be needed when the vessel is in motion.

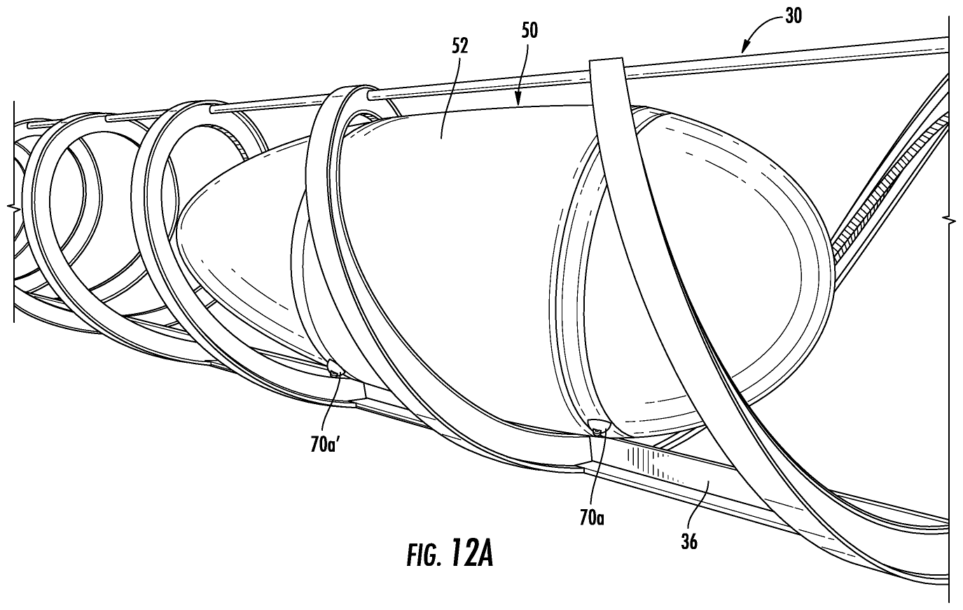

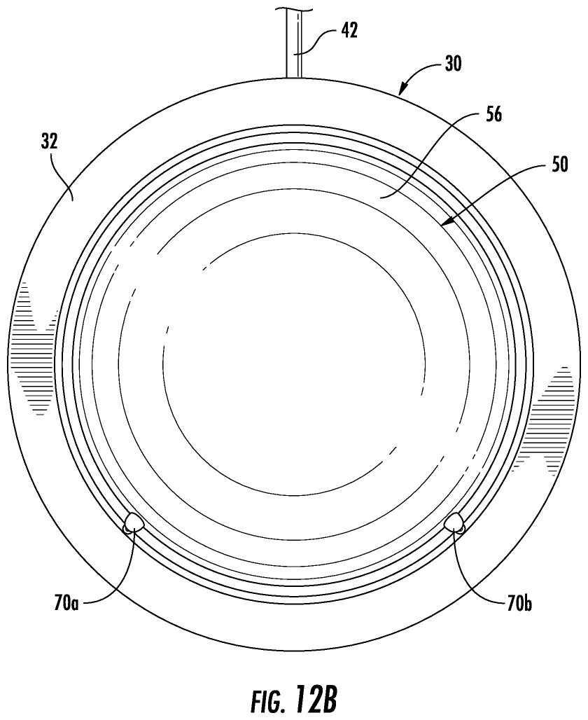

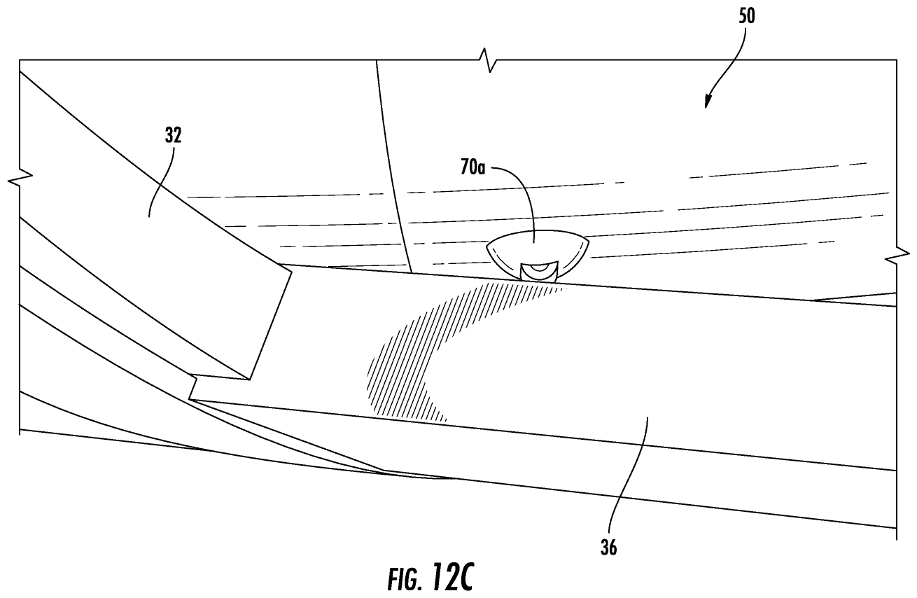

In another configuration, as shown in FIGS. 12A-12C and described in more detail herein, support elements, such as rollers or small wheels, can protrude from the outer shell of the vessel body 51 at a distance that is smaller than the smallest gap expected to occur during operation. Bearings or other suitable bearing-like elements could be implemented either on the outer surface of the vessel body 51 or on the inner surface of any portion of the track assembly 30.

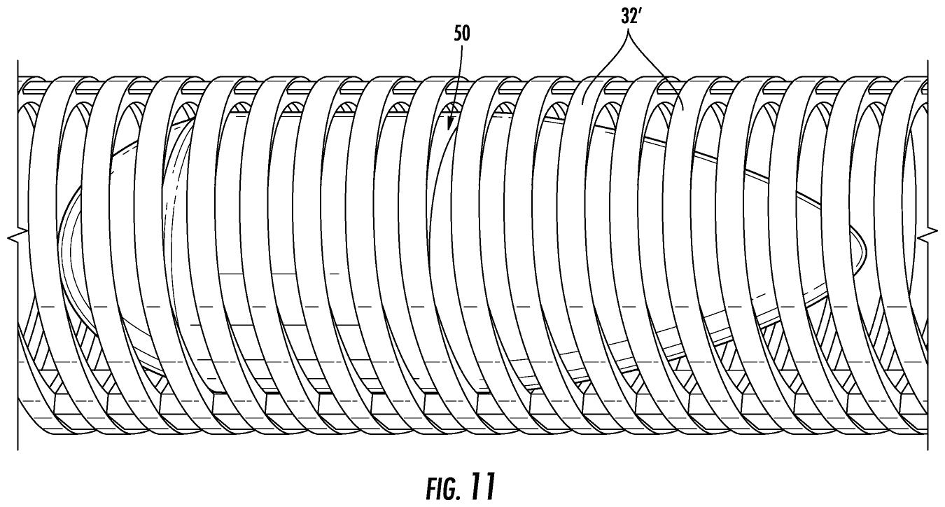

Also, at the places where the vessel assembly 50 will be going at a slow speed or be stopped, the pitch of the helical guideway 32 can be very small, so that the coils are very close together and very little propulsion, but a significant centering force will be generated as the reaction plate rotates. FIG. 11 illustrates one such configuration. As shown in FIG. 11, the coils or helical components of the guideway 32′ can have a relatively smaller pitch in certain regions of the track defined by the guideway. In one example, the smaller pitch will generate a greater force along the direction of the linear motion. Thus, a smaller pitch is ideal for accelerating from low speeds and braking to low speeds, and a larger pitch is ideal for a sustained high speed of linear motion.

Furthermore, additional rails with magnets can be provided in the guideway, running parallel to the longitudinal axis of the guideway (i.e., not helical), which would generate only drag and a centering force on the rotating reaction plate. This centering force will be exclusively levitation if an extra rail is at the bottom of the guideway, below the vessel. One of ordinary skill in the art would recognize based on this disclosure that various aspects of the propulsion system can be modified depending on the particular requirements of a specific application or system.

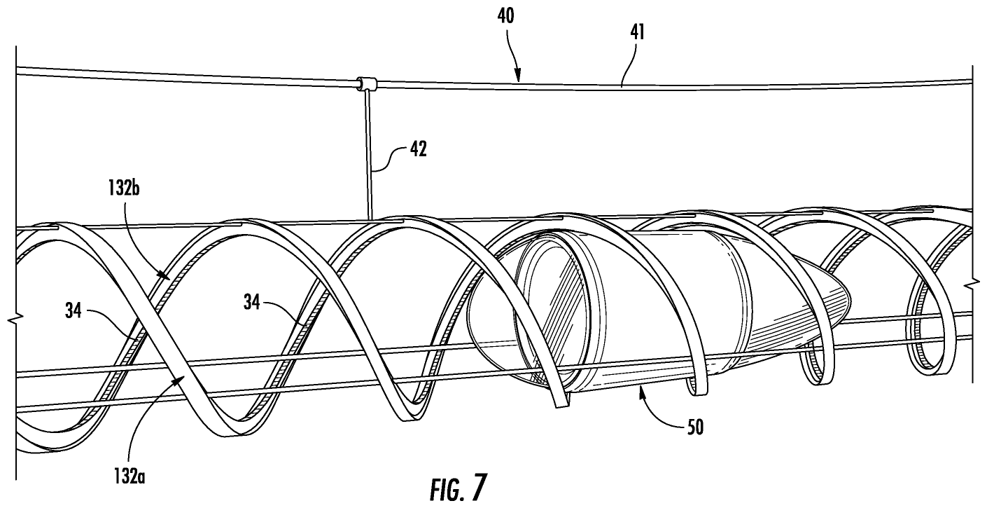

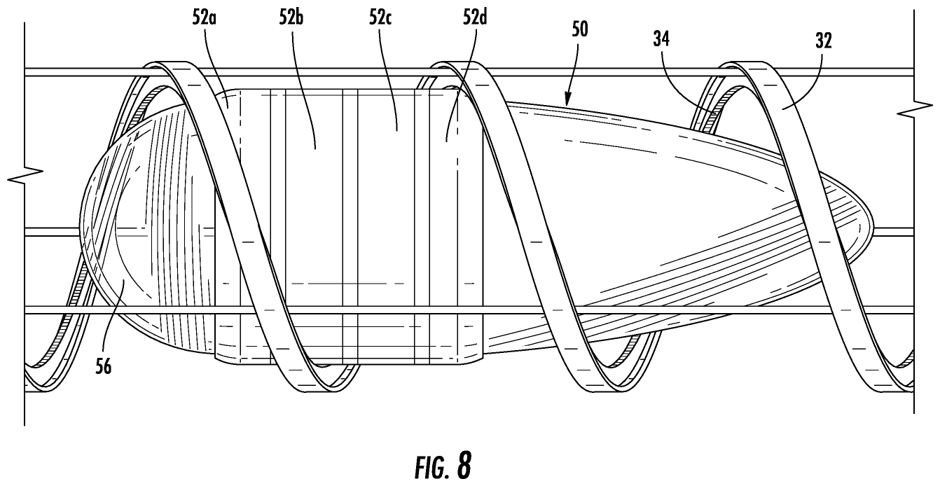

For example, in FIG. 7, a helical track is illustrated having a first helical track portion 132a and a second helical track portion 132b. A configuration with multiple helical tracks and arrays may be useful for certain applications that require greater stability, symmetrical support for the vessel and/or more interaction between the cylindrical reaction plate and the helical magnet arrays. The configuration shown in FIG. 7, i.e. with two helical tracks, can be used in any one or more of the other Figures, and operates under the same basic principle as the configurations and arrangements disclosed in the other Figures. A double helical configuration is also shown in FIGS. 3C and 3D, which also shows a first and second helical track portion 132a, 132b. In one configuration, the helical track portions 132a, 132b are diametrically opposed to each other, such that each one of the helical tracks is positioned 180 degrees from the other helical track. In one aspect, this diametric offset can be 170 degrees-190 degrees. One of ordinary skill in the art would understand that the configuration can vary depending on the specific requirements for a particular track assembly. The double helical track configuration can be used with any one or more of the other track portions or features described herein.

As shown in FIG. 9, the track assembly may further include at least one lower support rail 36, which may include bearing elements, magnets, or any other component. In one aspect, the support rail 36 includes a combination of bearing elements and magnets. In one aspect, the support rail 36 can be a plain track or rail. In other configurations, the support rail 36 can include magnets 34 similar to the helical rails or tracks, such that the reaction plate is repelled by the magnets on the support rail 36. The at least one lower support rail 36 can provide additional support for the vessel assembly 50, particularly in portions of the track assembly 30 that are generally to be used for lower speeds or stopped conditions. For example, the lower support rail 36 may be used on the track assembly 30 in regions of docking (i.e. where passengers are loaded into and out of the vessel assembly) or in regions of the track in the vicinity of these areas.

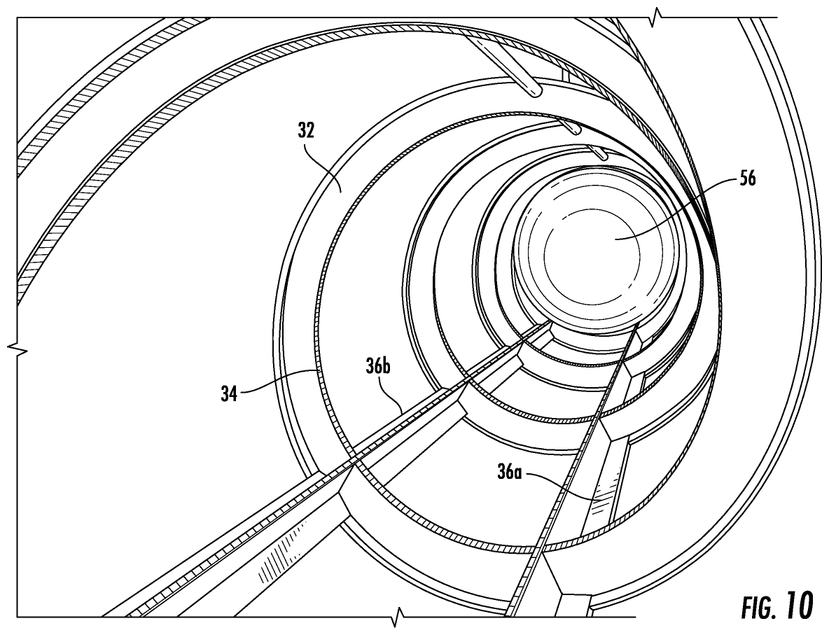

As shown in FIG. 10, the track assembly 30 may further include two lower support rail 36a, 36b on a lower or bottom side of the track assembly 30 in order to provide additional support for the vessel assembly 50 during low operating speeds or in a stopped condition. The lower support rails 36a, 36b can include two rails that are circumferentially spaced apart from each other by approximately 20 degrees-120 degrees. In one specific aspect, this spacing can be 60 degrees. The lower support rails 36a, 36b can include more than two support rails. The lower support rails 36a, 36b can project radially inward beyond an interior surface of the remainder of the guideway such that the vessel assembly 50 is configured to contact the lower support rails 36a, 36b and not the guideway 32 in a low operating speed or stopped condition. The lower support rails 36a, 36b can include bearing features or elements, magnets, or any other component or combination thereof (i.e. magnets and bearings). In one aspect, bearings are provided on the support rails 36a, 36b that are configured to provide a low friction surface for engagement with the vessel. The lower support rails 36a, 36b can extend in a longitudinal direction along the direction of travel and can have a straight profile, in one aspect.

As shown in FIGS. 12A-12C, at least one vessel support 70a, 70a′ 70b can be provided that is generally configured to provide a support for the vessel assembly 50, particularly during low speed conditions or a stopped condition. The vessel support 70a, 70a′, 70b can include, for example wheels, bearings, rollers, or other components configured to provide an interface between the vessel assembly 50 and the track assembly 30. The vessel support 70a, 70a′, 70b can be fixedly arranged to the vessel body 51 and be fixed in a lower or bottom region of the vessel body 51.

As shown in FIG. 12A, the vessel supports 70a, 70a′ can be provided in front of and behind the reaction plate 52, thereby providing support that is spaced axially apart from each other. The vessel supports 70a, 70a′ can be configured to engage with a lower rail, such as lower support rail 36.

As shown in FIG. 12B, the vessel support 70a, 70b can include two vessel supports 70a, 70b that are circumferentially spaced apart from each other. In one aspect, the vessel supports 70a, 70b can be configured to engage with lower support rails, such as the lower support rails 36a, 36b shown in FIG. 10. In this configuration, the vessel supports 70a, 70b and the lower support rails 36a, 36b can be aligned with each other. One of ordinary skill in the art would understand that the vessel supports 70a, 70b can be configured to engage with other aspects of the track assembly 30. The vessel supports 70a, 70a′, 70b can be retractable into a vessel body 51, in one configuration. Additionally, one of ordinary skill in the art would understand that many more supports can be provided on the vessel assembly 50.

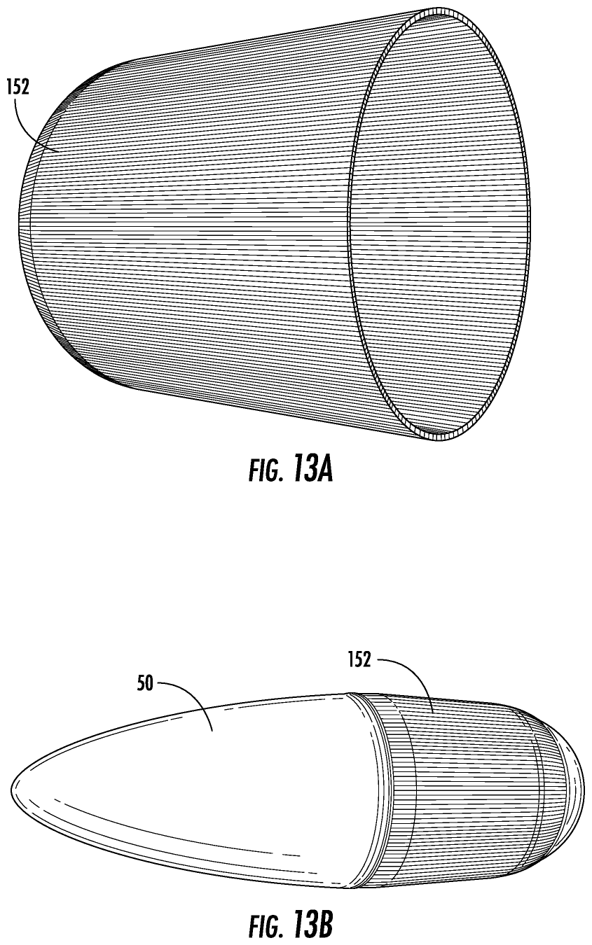

As shown in FIGS. 13A and 13B, alternative configurations can be provided for the reaction plate. In this embodiment, a reaction plate assembly 152 can be comprised of stacked thin, narrow plates of the same materials that may be used for the reaction plate 52, placed next to each other and running the full length of the reaction plate assembly 152. The thin plates can be aligned with their longitudinal axis, i.e. matching or approximately matching the longitudinal axis of the reaction plate assembly 152, and their short axis aligned or approximately aligned perpendicular to the surface of the reaction plate assembly 152. The dimensions of each of the plates of the reaction plate assembly 152 can be its longitudinal dimension equal to the overall length of the reaction plate assembly 152, and its short dimension equal to the thickness of the cylinder wall, and the thickness of the plate according to the desired cost, fabrication and performance design parameters, but approximately in the order of 1.0 mm to 10 mm. The thin plates can be separated by insulators or gaps, such that the currents induced in them by the magnetic fields will tend to be closely aligned with the longitudinal axis of the plates, which will be generally aligned with the longitudinal axis of the reaction plate assembly 152. In another aspect, the long, thin plates may have their longitudinal axis at an angle relative to the longitudinal axis of the cylinder, so that the currents induced in them by the magnetic fields will also tend to have an angle relative to the longitudinal axis of the cylinder, and thus the forces generated may have larger or smaller components along the axis parallel and perpendicular to the longitudinal axis of the cylinder.

In one aspect, a transportation system for people traveling between two locations is provided herein. A guideway goes from one location to the other location, suspended on steel or concrete poles, or any other suitable material. At each location there is a station, with possible intermediate stops. At the stations, the passengers enter a parked or stopped vessel assembly. In one instance, the stopped vessel body rests on small wheels or rollers (i.e. vessel supports 70a, 70a′, 70b) attached to the vessel body 51. In the stations and anywhere the vessel velocity will be reduced or stopped, the pitch of the guideway can be very small, with the coils relatively closely next to each other, so as to provide greater torque and less speed when the reaction plate 52 rotates. In one instance, when the passenger is safely in the vessel body 51, the motor 54 begins to rotate the reaction plate 52. As the reaction plate 52 rotates, it will begin to generate a centering force that will increase the gap between the vessel body 51 and the guideway 32, and also, the rotation of the reaction plate 52 will generate increasingly more forward thrust, and as the vessel body 51 moves forward, it will gradually move into the sections of the guideway 32 with a greater pitch, until the desired speed is attained. A typical desirable speed will be between 100 km/h and 400 km/h. Upon approaching its end station, the vessel body 51 will encounter a smaller pitch in the guideway 32, and it will also reduce the rate of rotation of the reaction plate 52 to gradually reduce its speed until it no longer creates enough levitation and centering force to keep the vessel supports 70a, 70a′, 70b from contacting the guideway 32, and the vessel body 51 comes to a complete stop. At this time, the passenger will exit the vessel body 51 by the access element 56.

A method of propelling a vessel assembly along a track assembly is also disclosed herein. The method includes arranging a vessel assembly inside of a track assembly comprising a helical guideway with magnets arranged on inwardly facing surfaces. The method includes rotating a reaction plate that is attached to the vessel body, such that the rotation of the reaction plate generates a centering force thereby lifting the centering the vessel assembly relative to the track assembly and a propulsion or driving force thereby propelling the vessel assembly along the track assembly. Additional method steps can be incorporated, including any of the features and steps described above.

A magnetic propulsion system is generally disclosed herein. The magnetic propulsion system includes a track assembly comprising at least one helical guideway extending along a longitudinal axis of the track assembly and having a plurality of magnets or a magnetic array arranged on an interior surface of the at least one helical guideway. A vessel assembly is included that has at least one reaction plate, and at least one motor configured to rotate the at least one reaction plate relative to the longitudinal axis such that the vessel assembly is propelled along the track assembly via rotation of the at least one reaction plate.

The at least one reaction plate can be formed as a metallic cylinder that is concentric with an outer surface of a body of the vessel assembly. The at least one reaction plate can be formed from aluminum or copper. The at least one reaction plate can include a plurality of reaction plates spaced apart from each other along an axial direction.

The motor can be arranged within an interior space defined by a body of the vessel assembly. The motor can be configured to drive a shaft connected to a first gear, and a second gear can be fixed to the at least one reaction plate. The first gear and the second gear can be matingly engaged with each other to rotate the at least one reaction plate.

The track assembly can be electrically static and does not require any power source. The at least one helical guideway can have a T-shaped profile when view in cross-section and the magnetic array can be arranged on a terminal end of the T-shaped profile.

Rotation of the at least one reaction plate can be configured to generate a centering force in a direction perpendicular to the longitudinal axis (X) of the track assembly and a propulsion force in a direction parallel to the longitudinal axis (X) of the track assembly.

The plurality of magnets or the magnetic array can consist of permanent magnets.

A control assembly can be configured to provide signals to the motor.

An energy storage unit can be configured to power the control assembly and the motor, and the control assembly and the energy storage unit can be arranged within an interior of the vessel assembly.

The at least one helical guideway can include two helical guideways that are diametrically opposed from each other and extend parallel to each other along the longitudinal axis of the track assembly. Each of the two helical guideways can have a respective plurality of magnets or magnetic array arranged on an interior surface thereof.

The track assembly can further comprise suspended supports for holding the helical guideway in place.

The track assembly can further include lower support rails that extend parallel to the longitudinal axis of the track assembly. The lower support rails can include a magnetic array or magnets, bearing components, or a combination thereof.

A pitch of the helical guideway can be variable, and include at least a first track area having a first pitch and at least a second track area having a second pitch, and the first pitch can be smaller than the second pitch.

Bearing components can be incorporated throughout the vessel assembly. For example, at least one axial bearing can be provided for supporting the reaction plate relative to a body of the vessel assembly in an axial direction and at least one radial bearing can be provided for supporting the reaction plate relative to the body of the vessel assembly in a radial direction.

The vessel assembly can include an access element configured to open and close such that a user can enter and exit the vessel assembly, and the access element can be formed as a transparent dome on a front portion of the vessel assembly.

The vessel assembly can include at least one vessel support provided on a lower half of the vessel assembly, and the track assembly can include at least one lower support rail. The at least one vessel support and the at least one lower support rail can be configured to engage with each other at least during a lower speed state or a rest state.

In another aspect, a magnetic propulsion system is disclosed herein that includes a track assembly having at least two helical guideways that are diametrically opposed from each other and each extend along a longitudinal axis of the track assembly. Each of the at least two helical guideways can include a magnetic array or plurality of magnets arranged on an interior surface thereof. The magnetic array or plurality of magnets can include permanent magnets. A vessel assembly can be included that has a body defining an interior space, at least one reaction plate arranged around an exterior of the body, at least one energy storage unit arranged within the interior space, and at least one motor arranged within the interior space and configured to be powered by the at least one energy storage unit to rotate the at least one reaction plate relative to the longitudinal axis such that the vessel assembly is propelled along the track assembly via rotation of the at least one reaction plate.

The motor can be configured to drive a shaft connected to a first gear, and a second gear can be fixed to the at least one reaction plate. The first gear and the second gear can matingly engage with each other to rotate the at least one reaction plate.

The body of the vessel assembly can define an opening through which the first gear protrudes to engage the second gear.

The vessel assembly can include an access element configured to open and close such that a user can enter and exit the vessel assembly, and the access element can be formed as a transparent dome on a front portion of the vessel assembly.

At least one axial bearing can be arranged between the at least one reaction plate and the body of the vessel assembly, and at least one radial bearing can be arranged between the at least one reaction plate and the body of the vessel assembly. The body of the vessel assembly can define a support surface to define an interface with the at least one axial bearing.

The vessel assembly can include a plurality of vessel supports provided on a lower half of the vessel assembly, and the track assembly can include at least one lower support rail. The plurality of vessel supports can be configured to interface with the at least one lower support rail for supporting the vessel assembly during a lower speed state or a rest state.

The body of the vessel assembly can have a diameter of 1 meter. This can be measured relative to an interior wall of the body, in one example. In another example, this can be the diameter as measured relative to an outer wall of the body.

A method of propelling a vessel assembly along a track assembly is also disclosed herein. The method can include multiple steps, such as providing a track assembly including a magnetic array fixed along at least one helical guideway. The method can include positioning a vessel assembly within an interior track defined by the helical guideway. The vessel assembly can include at least one reaction plate that surrounds a body of the vessel assembly. The method can include rotationally driving the at least one reaction plate such that at least a propulsion force is generated via interaction of the at least one reaction plate with the magnetic array and the vessel assembly is propelled along the track assembly.

According to one aspect, a vessel assembly is disclosed herein that is configured to be propelled within a track assembly. The vessel assembly includes a body including at least one radial support surface and at least one axial support surface, a reaction plate configured to surround the body that is supported against the at least one radial support surface and the at least one axial support surface, and a motor configured to rotationally drive the reaction plate such that the reaction plate generates at least a propulsion force via interaction with permanent magnets arranged along a helical guideway of the track assembly.

In another aspect, a track assembly is disclosed that is configured to guide a vessel assembly that is propelled therein. The track assembly includes at least one helical guideway including a magnetic array extending along the at least one helical guideway. The magnetic array has permanent magnets configured to interact with a rotating reaction plate that is supported around an exterior surface of the vessel assembly.

Having thus described various embodiments of the present system and method in detail, it will be appreciated and apparent to those skilled in the art that many changes, only a few of which are exemplified in the detailed description above, could be made in the adjustable support device according to the invention without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A magnetic propulsion system comprising:
a track assembly comprising at least one helical guideway extending along a longitudinal axis of the track assembly and having a plurality of magnets arranged on an interior surface of the at least one helical guideway, and
a vessel assembly comprising:
at least one reaction plate, and
at least one motor configured to rotate the at least one reaction plate relative to the longitudinal axis such that the vessel assembly is propelled along the track assembly via rotation of the at least one reaction plate.

2. The magnetic propulsion system according to claim 1, wherein the at least one reaction plate is formed as a metallic cylinder that is concentric with an outer surface of a body of the vessel assembly.

3. The magnetic propulsion system according to claim 1, wherein the at least one reaction plate is formed from aluminum or copper.

4. The magnetic propulsion system according to claim 1, wherein the motor is arranged within an interior space defined by a body of the vessel assembly.

5. The magnetic propulsion system according to claim 1, wherein the at least one reaction plate includes a plurality of reaction plates spaced apart from each other along an axial direction.

6. The magnetic propulsion system according to claim 1, wherein the track assembly is electrically static and lacks any power source.

7. The magnetic propulsion system according to claim 1, wherein rotation of the at least one reaction plate is configured to generate at least a centering force in a direction perpendicular to the longitudinal axis (X) of the track assembly and a propulsion force in a direction parallel to the longitudinal axis (X) of the track assembly.

8. The magnetic propulsion system according to claim 1, wherein the plurality of magnets consists of permanent magnets.

9. The magnetic propulsion system according to claim 1, wherein the at least one helical guideway has a T-shaped profile when view in cross-section and the magnets are arranged on a terminal end of the T-shaped profile.

10. The magnetic propulsion system according to claim 1, wherein the motor is configured to drive a shaft connected to a first gear, and a second gear is fixed to the at least one reaction plate, and the first gear and the second gear matingly engage with each other to rotate the at least one reaction plate.

11. The magnetic propulsion system according to claim 1, further comprising:
a control assembly configured to provide signals to the motor; and
an energy storage unit configured to power the control assembly and the motor, wherein the control assembly and the energy storage unit are arranged within an interior of the vessel assembly.

12. The magnetic propulsion system according to claim 1, wherein the at least one helical guideway includes two helical guideways that are diametrically opposed from each other and extend parallel to each other along the longitudinal axis of the track assembly and each have a respective plurality of magnets arranged on an interior surface thereof.

13. The magnetic propulsion system according to claim 1, wherein the track assembly further comprises suspended supports for holding the at least one helical guideway in place.

14. The magnetic propulsion system according to claim 1, wherein the track assembly further comprises at least one lower support rail that extends parallel to the longitudinal axis of the track assembly, wherein the at least one lower support rail includes another plurality of magnets.

15. The magnetic propulsion system according to claim 1, wherein a pitch of the at least one helical guideway is variable, and includes at least a first track area having a first pitch and at least a second track area having a second pitch, wherein the first pitch is smaller than the second pitch.

16. The magnetic propulsion system according to claim 1, further comprising at least one axial bearing for supporting the at least one reaction plate relative to a body of the vessel assembly in an axial direction and at least one radial bearing for supporting the at least one reaction plate relative to the body of the vessel assembly in a radial direction.

17. The magnetic propulsion system according to claim 1, wherein the vessel assembly further comprises an access element configured to open and close such that a user can enter and exit the vessel assembly, wherein the access element is formed as a transparent dome on a front portion of the vessel assembly.

18. The magnetic propulsion system according to claim 1, wherein the vessel assembly further comprises at least one vessel support provided on a lower half of the vessel assembly, and the track assembly further comprises at least one lower support rail and the at least one vessel support and the at least one lower support rail are configured to engage with each other at least during a lower speed state or a rest state.

19. A magnetic propulsion system comprising:
a track assembly comprising at least two helical guideways that are diametrically opposed from each other and each extend along a longitudinal axis of the track assembly, each of the at least two helical guideways including a magnetic array arranged on an interior surface thereof, wherein the magnetic array includes permanent magnets; and
a vessel assembly comprising a body defining an interior space, at least one reaction plate arranged around an exterior of the body, at least one energy storage unit arranged within the interior space, at least one motor arranged within the interior space and configured to be powered by the at least one energy storage unit to rotate the at least one reaction plate relative to the longitudinal axis such that the vessel assembly is propelled along the track assembly via rotation of the at least one reaction plate.

20. The magnetic propulsion system according to claim 19, wherein the motor is configured to drive a shaft connected to a first gear, and a second gear is fixed to the at least one reaction plate, and the first gear and the second gear matingly engage with each other to rotate the at least one reaction plate.

21. The magnetic propulsion system according to claim 20, wherein the body of the vessel assembly defines an opening through which the first gear protrudes to engage the second gear.

22. The magnetic propulsion system according to claim 19, wherein the vessel assembly further comprises an access element configured to open and close such that a user can enter and exit the vessel assembly, and the access element is formed as a transparent dome on a front portion of the vessel assembly.

23. The magnetic propulsion system according to claim 19, further comprising at least one axial bearing for supporting the at least one reaction plate relative to the body of the vessel assembly in an axial direction, and at least one radial bearing for supporting the at least one reaction plate relative to the body of the vessel assembly in a radial direction.

24. The magnetic propulsion system according to claim 23, wherein the body of the vessel assembly defines a support surface to define an interface with the at least one axial bearing.

25. The magnetic propulsion system according to claim 19, wherein the vessel assembly further comprises a plurality of vessel supports provided on a lower half of the vessel assembly, and the track assembly further comprises at least one lower support rail and the plurality of vessel supports are configured to interface with the at least one lower support rail for supporting the vessel assembly during a lower speed state or a rest state.

26. The magnetic propulsion system according to claim 19, wherein the at least one reaction plate is formed from copper.

27. The magnetic propulsion system according to claim 19, wherein the body of the vessel assembly has a diameter of 1 meter.

28. A method of propelling a vessel assembly along a track assembly, the method comprising:
providing a track assembly including a magnetic array fixed along at least one helical guideway;
positioning a vessel assembly within an interior track defined by the helical guideway, wherein the vessel assembly includes at least one reaction plate that surrounds a body of the vessel assembly; and
rotationally driving the at least one reaction plate such that at least a propulsion force is generated via interaction of the at least one reaction plate with the magnetic array and the vessel assembly is propelled along the track assembly.

29. The method according to claim 28, wherein the vessel assembly includes a motor configured to rotate the at least one reaction plate, and wherein the magnetic array includes permanent magnets and is not electrically powered.

30. The method according to claim 29, wherein the at least one helical guideway includes two helical guideways that are diametrically opposed from each other and extend parallel to each other along the longitudinal axis of the track assembly and each have a respective plurality of magnets arranged on an interior surface thereof.

31. A vessel assembly configured to be propelled within a track assembly, the vessel assembly comprising:
a body including at least one radial support surface and at least one axial support surface;
a reaction plate configured to surround the body and be supported against the at least one radial support surface and the at least one axial support surface; and
a motor configured to rotationally drive the reaction plate such that the reaction plate generates at least a propulsion force via interaction with permanent magnets arranged along a helical guideway of the track assembly.

32. A track assembly configured to guide a vessel assembly that is propelled therein, the track assembly comprising:
at least one helical guideway including a magnetic array extending along the at least one helical guideway, the magnetic array comprising permanent magnets configured to interact with a rotating reaction plate supported around an exterior surface of the vessel assembly.
